(19) United States
(12) Patent Application Publication
(10) Pub. No.: US 2026/0270215 A1
(43) Pub. Date: Sep. 10, 2026

(54) SYSTEMS AND METHODS FOR NETWORK TERMINATION DEVICE AGGREGATION

(71) Applicant: Cable Television Laboratories, Inc., Louisville, CO (US)

(72) Inventors: Randy Levensalor, Boulder, CO (US); Aaron Quinto, Erie, CO (US); Jonathan Ray Dennis, Aurora, CO (US)

(21) Appl. No.: 19/554,938

(22) Filed: Mar. 3, 2026

Related U.S. Application Data
(60) Provisional application No. 63/766,516, filed on Mar. 4, 2025.

(51) Int. Cl. H04L 47/41

(52) U.S. Cl. CPC H04L 47/41

(57) ABSTRACT

A method for network termination device aggregation includes (i) provisioning a first network termination device at a subscriber’s location to use first communication resources of an access communication network, (ii) provisioning a second network termination device at the subscriber's location to use second communication resources of the access communication network, (iii) transmitting first data between a provider link aggregation element and a subscriber link aggregation element via a first logical network link including the first network termination device, and (iv) transmitting second data between the provider link aggregation element and the subscriber link aggregation element via a second logical network link including the second network termination device.

### RELATED APPLICATIONS

This application claims benefit of United States Provisional Patent Application Number 63/766,516, filed on Mar. 4, 2025, which is incorporated herein by reference. The following patents are also incorporated herein by reference: (a) United States Patent Number 11,937,167 to Smith et al. and (b) United States Patent Number 11,757,774 to Smith et al.

### BACKGROUND

Communication networks are very common in modern society. For example, access communication networks are widely used to provide communication services, such as Internet service, telephone service, video service, etc., to end users in respective geographic areas. As another example, long-haul communication networks are extensively used to transport data across long distances, such as across countries, across continents, or across oceans.

Communication networks are commonly modeled using an open systems interconnection (OSI) model, where each node in the network is represented by an OSI layer stack. FIG. 1 illustrates an OSI layer stack 100 including the following layers: (i) a physical layer 102, (ii) a data link layer 104, (iii) a network layer 106, (iv) a transport layer 108, (v) a session layer 110, (vi) a presentation layer 112, and (vii) an application layer 114. Each layer, except for physical layer 102 and application layer 114, provides an interface between immediately adjacent layers. For example, data link layer 104 provides an interface between physical layer 102 and network layer 106. As another example, network layer 106 provides an interface between data link layer 104 and transport layer 108.

Physical (PHY) layer 102, also referred to as “Layer-1,” facilitates transfer of data symbols, such as raw bits, across a physical communication medium (e.g., an electrical cable, an optical cable, or free space). For example, Layer 1 may define interfaces with a communication medium, control bit rate, control synchronization, etc.

Data link layer 104, also referred to as “Layer-2,” may encode transmission entities received from upper layers into raw bits for physical layer 102. Additionally, data link layer 104 may decode raw bits received from physical layer 102 into transmission entities for upper layers. Furthermore, data link layer 104 may provide transmission protocol and management, frame synchronization, and flow control. Data link layer 104 often includes two sublayers, i.e., a medium access control (MAC) sublayer 116 and a logical link control (LLC) sublayer 118. MAC sublayer 116 provides flow control and multiplexing for a transmission medium, and LLC sublayer 118 provides flow control and multiplexing for a logical link. MAC sublayer 116 sometimes includes two constituent elements (not shown), i.e., an upper MAC and a lower MAC. The upper MAC interacts with LLC sublayer 118, and the lower MAC interacts with PHY layer 102. A data unit created at Layer-2 is referred to as a data frame, and examples of communication protocols that operate at Layer-2 include Ethernet and Wi-Fi.

Network layer 106, also referred to as “Layer-3,” provides switching, routing, and logical addressing of packets across networks. One example of possible logical addressing performed by network layer 106 is establishment of Internet Protocol (IP) addresses. A data unit created at Layer-3 is referred to as a data packet, and an example of a communication protocol that operates at Layer-3 is the Internet Protocol.

Transport layer 108, also referred to as “Layer-4,” manages end-to-end communication and reliability such as by performing data segmentation and reassembly, data flow control, and data error detection and recovery. Examples of communication protocols that operate at Layer-4 include Transmission Control Protocol (TCP) and User Datagram Protocol (UDP).

Session layer 110, also referred to as “Layer-5,” controls connections between applications, such as by handing setup, coordination, and termination of conversations. Presentation layer 112, also referred to as “Layer-6,” translates between an application format and a network format. Layer-6 may also handle data encryption/decryption and data compression. Finally, application layer 114, also referred to as “Layer-7,” supports application processes. Examples of communication protocols that operate at Layer-7 include HTTPS, SMTP, FTP, and DNS.

### SUMMARY

In an embodiment, a method for network termination device aggregation includes (i) provisioning a first network termination device at a subscriber’s location to use first communication resources of an access communication network, (ii) provisioning a second network termination device at the subscriber's location to use second communication resources of the access communication network, the second communication resources of the access communication network being different from the first communication resources of the access communication network, (iii) at a provider link aggregation element, splitting downlink communication traffic destined for the subscriber’s location into at least a first downlink data flow and a second downlink data flow, (iv) transmitting the first downlink data flow to a subscriber link aggregation element via a first logical network link, the first logical network link including the first network termination device and communicatively coupling the subscriber link aggregation element with the provider link aggregation element, and (v) transmitting the second downlink data flow to the subscriber link aggregation element via a second logical network link, the second logical network link including the second network termination device and communicatively coupling the subscriber link aggregation element with the provider link aggregation element.

In an embodiment, a method for network termination device aggregation includes (i) at a subscriber link aggregation element, splitting uplink communication traffic into at least a first uplink data flow and a second uplink data flow, (ii) sending the first uplink data flow to a provider link aggregation element via a first logical network link, the first logical network link including a first network termination device and communicatively coupling the subscriber link aggregation element with the provider link aggregation element, the first network termination device being located at a subscriber’s location and being provisioned first communication resources of an access communication network, and (iii) sending the second uplink data flow to the provider link aggregation element via a second logical network link, the second logical network link including a second network termination device and communicatively coupling the subscriber link aggregation element with the provider link aggregation element, the second network termination device being located at the subscriber’s location and being provisioned second communication resources of the access communication network, the second communication resources of the access communication network being different from the first communication resources of the access communication network.

In an embodiment, a method for network termination device aggregation includes (i) transmitting first Layer-2 data frames between a provider link aggregation element and a subscriber link aggregation element using a first logical network link including a first network termination device and (ii) transmitting second Layer-2 data frames between the provider link aggregation element and the subscriber link aggregation element using a second logical network link including a second network termination device, wherein the first network termination device and the second network termination device are provisioned different respective communication resources of a common access communication network.

### BRIEF DESCRIPTION OF THE DRAWINGS

FIG. 1 is an illustration of an open systems interconnection (OSI) layer stack.

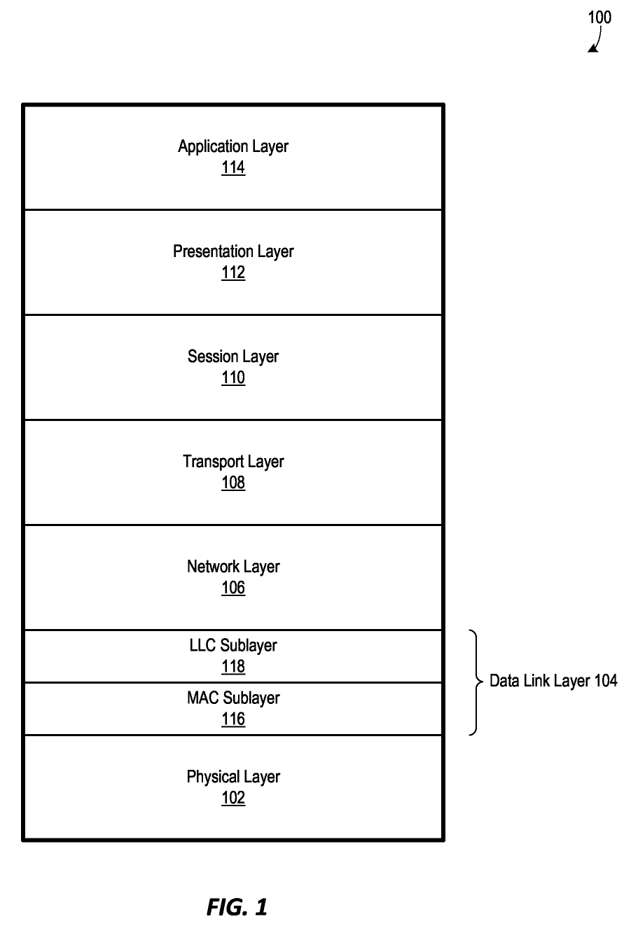

FIG. 2 is a block diagram of a communication environment including a system for network termination device aggregation, according to an embodiment.

FIG. 3 is a data flow diagram illustrating one example of downlink data flow in the FIG. 2 communication environment.

FIG. 4 is a data flow diagram illustrating one example of uplink data flow in the FIG. 2 communication environment.

FIG. 5 depicts two Layer-2 data flows in an embodiment of the FIG. 2 communication environment where an access communication network operates according to a Data Over Cable Service Interface Specification (DOCSIS) communication protocol.

FIG. 6 is a block diagram of an embodiment of the FIG. 2 communication environment where a communication service provider’s network is embodied by a cable communication service provider’s network.

FIG. 7 is a data flow diagram illustrating one example of downlink data flow in the FIG. 6 communication environment.

FIG. 8 is a data flow diagram illustrating one example of uplink data flow in the FIG. 6 communication environment.

FIG. 9 is a block diagram illustrating one example implementation of cable modems and a subscriber link aggregation (LAG) element of the FIG. 6 communication environment.

FIG. 10 is a block diagram illustrating another example implementation of cable modems and the LAG element of the FIG. 6 communication environment.

FIG. 11 is a block diagram of an embodiment of the FIG. 2 communication environment where a communication service provider’s network is embodied by a passive optical network (PON) communication service provider’s network.

FIG. 12 is a data flow diagram illustrating one example of downlink data flow in the FIG. 11 communication environment.

FIG. 13 is a block diagram of an embodiment of the FIG. 2 communication environment where a communication service provider’s network is embodied by a cellular communication service provider’s network.

FIG. 14 is a data flow diagram illustrating one example of downlink data flow in the FIG. 13 communication environment.

FIG. 15 is a block diagram of an embodiment of the FIG. 2 communication environment where a communication service provider’s network is embodied by a satellite communication service provider’s network.

FIG. 16 is a data flow diagram illustrating one example of downlink data flow in the FIG. 15 communication environment.

FIG. 17 is a block diagram of an alternate embodiment of the FIG. 2 communication environment including an additional network termination device at a subscriber’s location.

FIG. 18 is a data flow diagram illustrating one example of downlink data flow in the FIG. 17 communication environment.

FIG. 19 is a data flow diagram illustrating one example of uplink data flow in the FIG. 17 communication environment.

### DEFINITIONS

The following are definitions of certain terms used in this document:

Access communication network: a communication network that communicatively couples devices at multiple subscriber locations to a core communication network.

Core communication network: a communication network that is logically upstream of an access communication network and provides services such as data structure routing, communication service delivery, and communication policy enforcement.

Network termination device: a portion of an access communication network that is at a subscriber’s location and communicatively interfaces one or more devices at the subscriber’s location with the access communication network. Examples of a network termination device include, but are not limited to, a modem (e.g., a cable modem, a cellular wireless modem, or a satellite wireless modem), an optical network unit (ONU), and an optical network termination (ONT).

### DETAILED DESCRIPTION OF THE EMBODIMENTS

Access communication network capacity has increased substantially in recent years. For example, many cable access communication networks have been upgraded to increase operating frequency range as well as to implement advanced modulation techniques, thereby substantially increasing network capacity. As another example, increases in spectrum availability, as well as implementation of new communication protocols, have significantly increased capacity of cellular wireless communication networks.

However, capacity available to a given subscriber is frequently constrained by a network termination device, e.g., by a modem, at the subscriber’s location, because network termination devices are frequently incapable of fully using an access communication network’s capacity. For example, while a cable access communication network might support eight orthogonal frequency division multiplexing (OFDM) downlink channels, a subscriber’s cable modem might only support five OFDM downlink channels. As such, the subscriber would be unable to access the full capacity of the cable access communication network due to limitations of their cable modem. Additionally, even if a network termination device supporting full access communication network capacity is available, it is likely to be costly.

Disclosed herein are systems and methods for network termination device aggregation which at least partially overcome one or more of the above-discussed problems. The new systems and methods use two or more network termination devices at a subscriber’s location, and each network termination device is differently provisioned respective communication resources of an access communication network. Each network termination device is part of a respective logical network link that logically connects a subscriber link aggregation (LAG) element at the subscriber’s location with a provider LAG element upstream of the access communication network, or at a north end of the access communication network.

The new systems and methods disclosed herein may achieve significant advantages. For example, the use of two or more network termination devices at a subscriber’s location may significantly increase capacity of an access communication network that is available for subscriber use, thereby enabling the subscriber to obtain higher communication bandwidth and/or lower communication latency than would otherwise be feasible. As another example, the use of two or more network termination devices at a subscriber’s location provides redundancy, thereby helping maintain communication service at the subscriber’s location even if one of the network termination devices is impaired or is off-line (e.g., off-line due to rebooting). As an additional example, some embodiments use low cost and/or commonly available network termination devices, thereby promoting low system cost and ease of termination device inventory management. As a further example, in certain embodiments, the logical network links operate at Layer-2, thereby promoting compatibility with a wide range of Layer-3 communication protocols.

As another example, particular embodiments leverage a link aggregation control protocol (LACP), or another control protocol, to control the logical network links, such as to promote flexibility and/or reliability of data transmission using the logical network links. As an additional example, some embodiments are compatible with existing access communication networks and their communication protocols, thereby minimizing, or even eliminating, the need for modifications to existing access communication networks. As a further example, some embodiments are capable of one or more of (i) limiting packet loss and jitter, (ii) extended monitoring, (iii) traffic flow analysis, (iv) supporting feedback loops, (v) implementing optimization strategies, and (vi) performing issue resolution, thereby further promoting high performance, high reliability, and flexibility. Accordingly, the new systems and methods may materially advance access communication network performance and reliability while requiring minimal infrastructure modifications and additional cost.

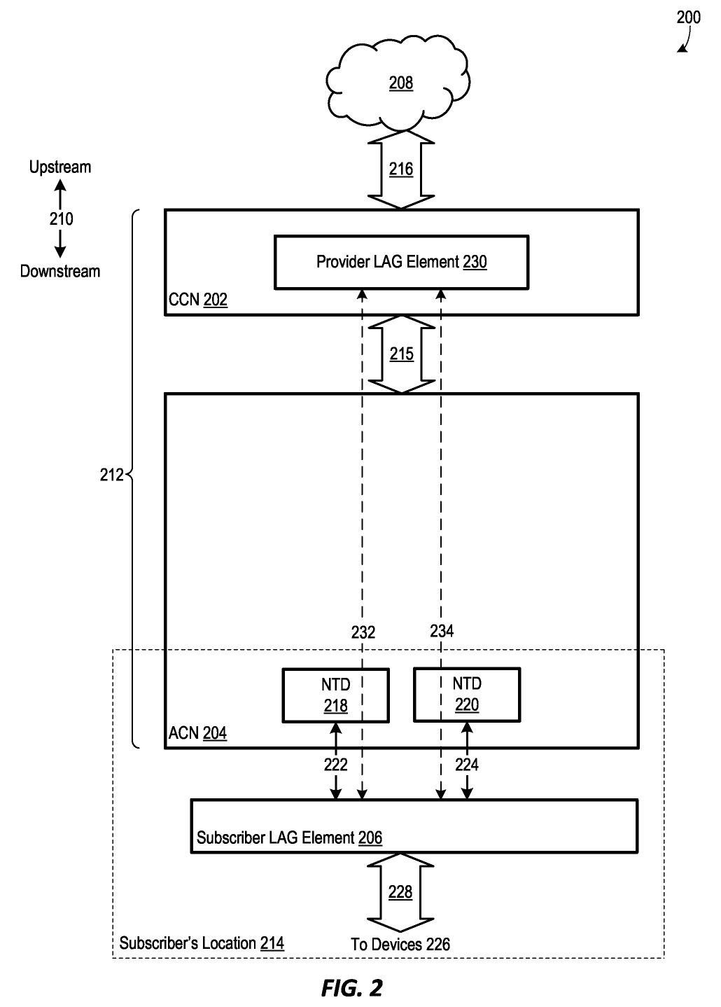

FIG. 2 is a block diagram of a communication environment 200 which includes one embodiment of the new systems for network termination device aggregation. Communication environment 200 includes a core communication network (CCN) 202, an access communication network (ACN) 204, a subscriber LAG element 206, and external network resources 208. FIG. 2 also includes an arrow 210 indicating upstream and downstream directions in FIG. 2. External network resources 208, which are upstream of core communication network 202, include, for example, one or more of the Internet, an Intranet, a content delivery server, a data storage server, a conferencing server, a messaging server, a gaming server, etc. Core communication network 202 and access communication network 204 collectively form a communication service provider’s network 212. Core communication network 202 is upstream of access communication network 204, and core communication network 202 is communicatively coupled to access communication network 204, as symbolically shown by an arrow 215. Additionally, core communication network 202 is communicatively coupled to external network resources 208 as symbolically shown by an arrow 216. Communication service provider’s network 212 is configured to provide communication service at different respective subscribers’ locations, such as by communicatively coupling subscribers’ locations to external network resources 208. While FIG. 2 only depicts a single subscriber’s location, i.e., a subscriber’s location 214, due to illustrative space constraints, it is understood that communication service provider’s network 212 may, and typically will, be configured to serve many subscriber locations, such as hundreds, thousands, tens of thousands, or more, subscriber locations.

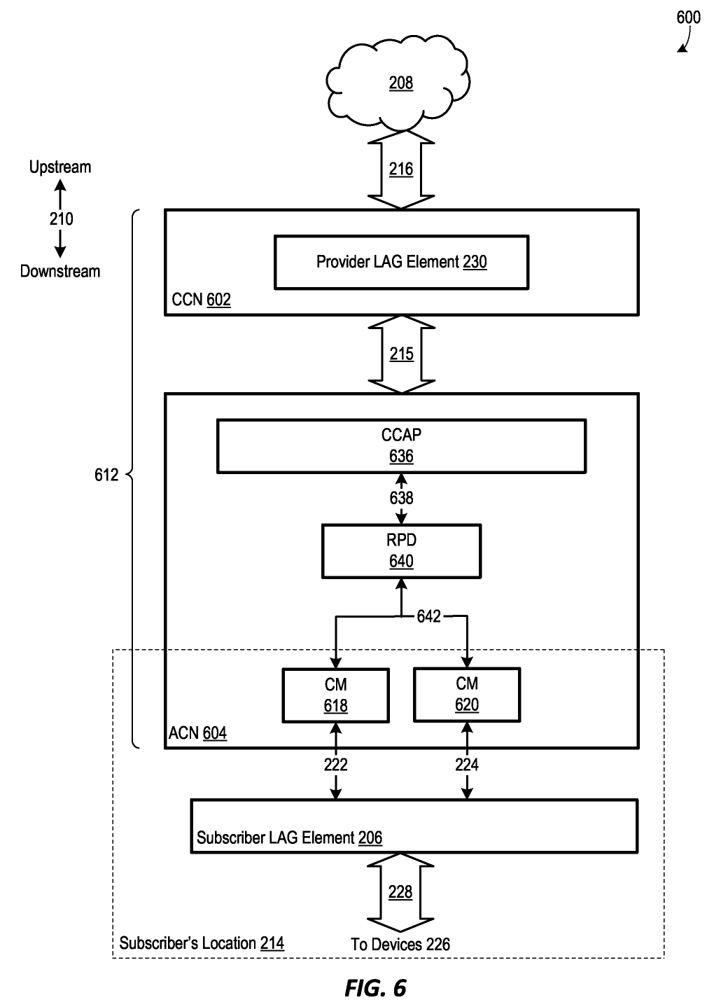

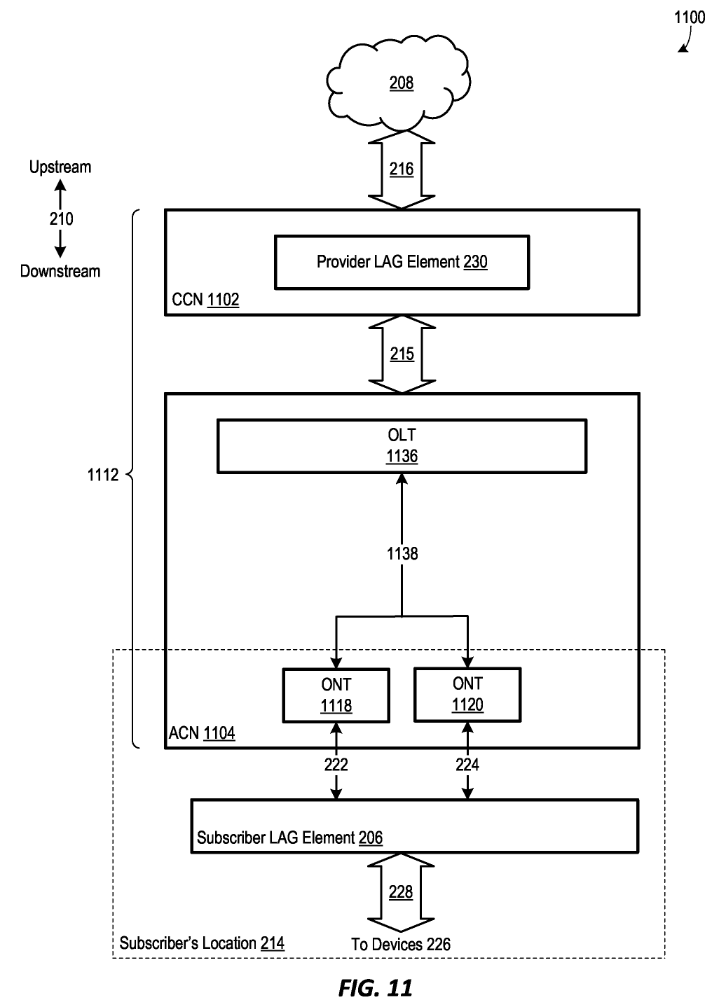

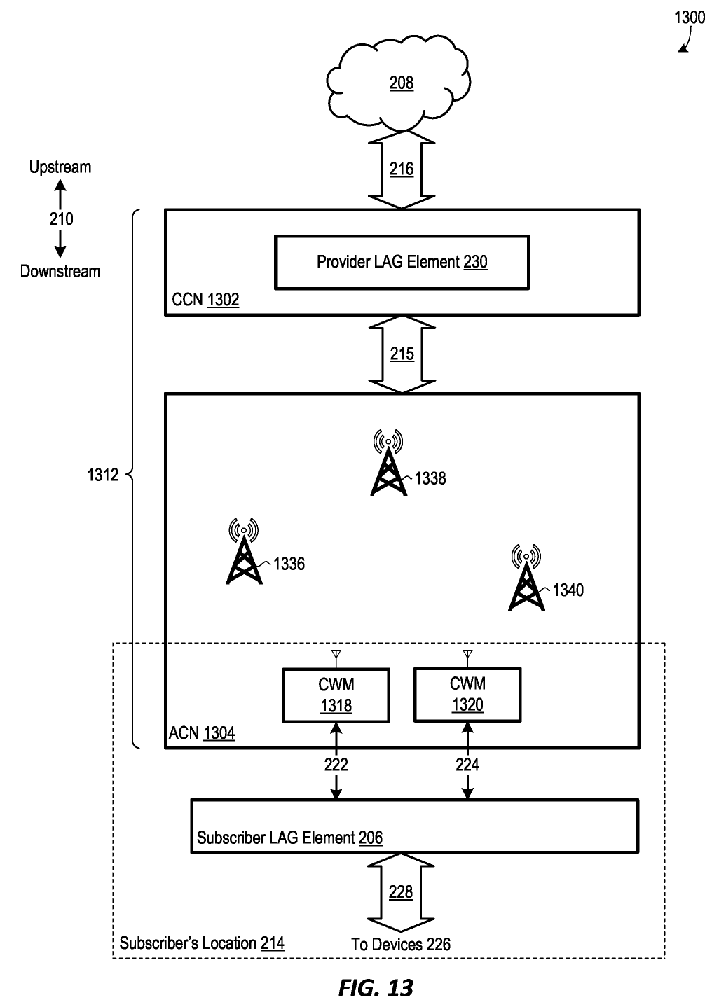

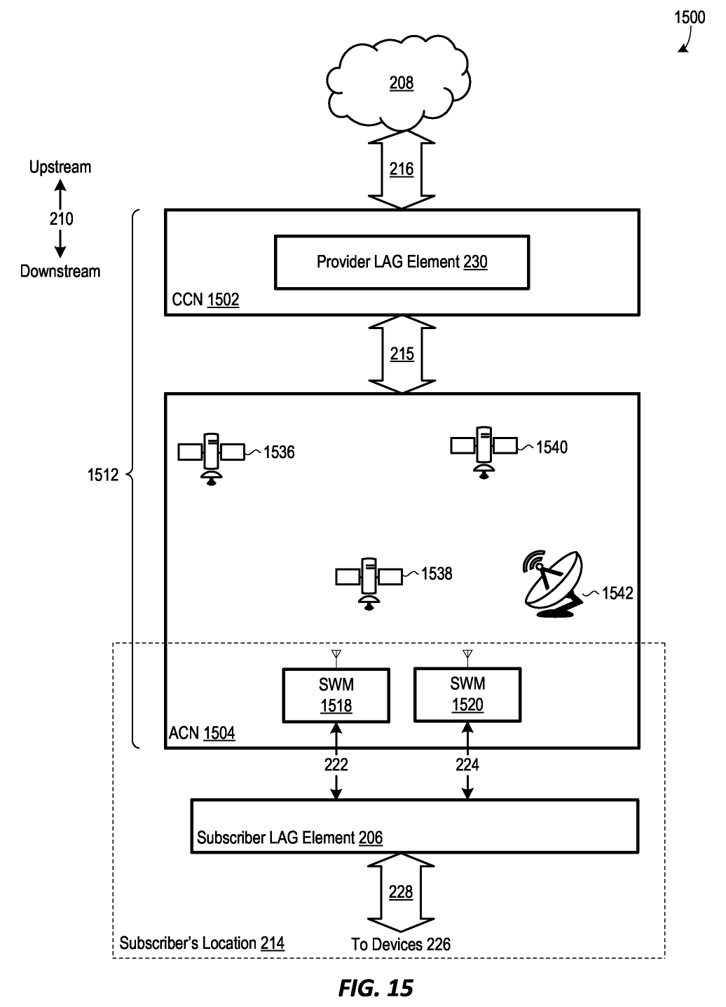

In some embodiments, communication service provider’s network 212 is a cable communication service provider’s network, such as cable communication service provider’s network 612 of FIG. 6. In these embodiments, access communication network 204 is a cable access communication network, such as cable access communication network 604 of FIG. 6, operating according to a cable communication protocol, e.g., a Data Over Cable Service Interface Specification (DOCSIS) communication protocol. In some other embodiments, communication service provider’s network 212 is a passive optical network (PON), such as PON communication service provider’s network 1112 of FIG. 11. In these embodiments, access communication network 204 is a PON access communication network, such as PON access communication network 1104 of FIG. 11, operating according to a PON communication protocol, e.g., an Ethernet PON (EPON) communication protocol, a gigabit (GPON) communication protocol, an XG-PON communication protocol, an XGS-PON communication protocol, an NG-PON2 communication protocol, or a coherent PON (CPON) communication protocol, etc. In some additional embodiments, communication service provider’s network 212 is a cellular wireless communication network, such as cellular communication service provider’s network 1312 of FIG. 13. In these embodiments, access communication network 204 is a radio access network (RAN), such as cellular access communication network 1304 of FIG. 13, that operates according to a Third Generation Partnership Project (3GPP) communication protocol, e.g., a fourth generation (4G) 3GPP communication protocol, a fifth generation (5G) 3GPP communication protocol, a sixth generation (6G) 3GPP communication protocol, or a successor thereof. In some further embodiments, communication service provider’s network 212 is satellite wireless communication network, such as satellite communication service provider’s network 1512 of FIG. 15. In these embodiments, access communication network 204 is satellite access communication network, such as satellite access communication network 1504 of FIG. 15, that operates according to a satellite communication protocol or a non-terrestrial version of a 3GPP communication protocol, e.g., 5G NR-NTN and successors thereof. However, it is understood that communication service provider’s network 212 could be a type of communication network other than those of the example embodiments discussed above. Additionally, access communication network 204 could use a different communication protocol than those discussed above. Furthermore, communication service provider’s network 212 could be a converged communication network supporting two or more different communication protocols. For example, in some embodiments, each of logical network link 232 and logical network link 234 are implemented by different respective access communication protocols in access communication network 204.

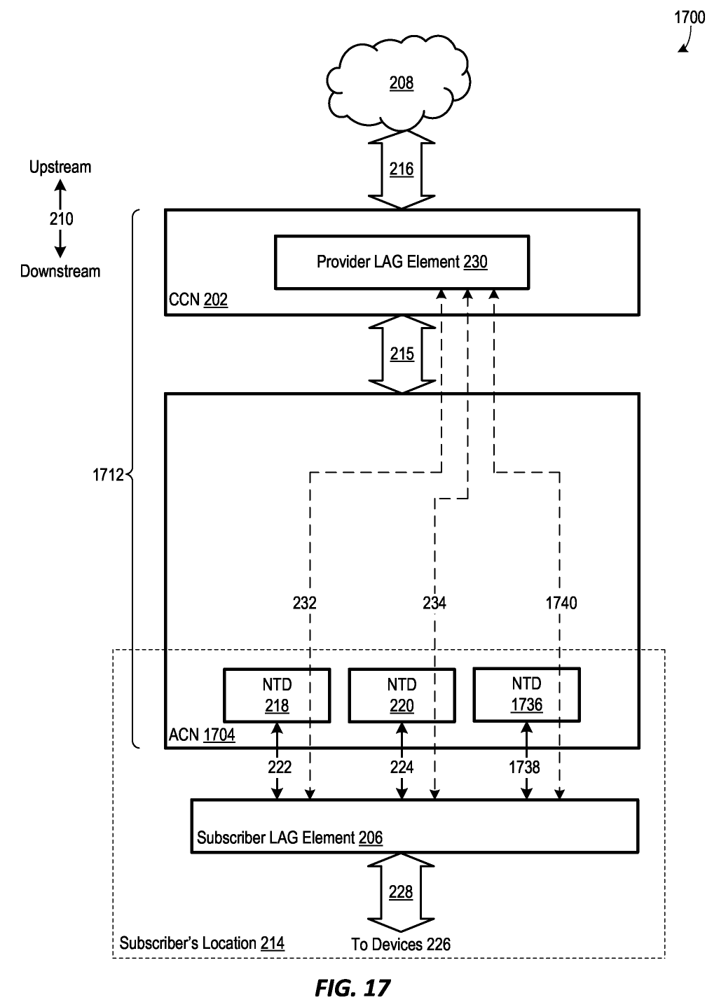

Access communication network 204 includes a network termination device (NTD) 218 and a network termination device 220 at subscriber’s location 214. As such, network termination device 218 and network termination device 220 are portions of access communication network 204 that extend to subscriber’s location 214. It is understood that access communication network 204 will include additional elements that are not shown for illustrative clarity and will vary according to the type of access communication network 204. Additionally, access communication network 204 will typically include additional network termination devices at additional subscribers’ locations, although these additional network termination devices are not shown due to illustrative space constraints. Furthermore, access communication network 204 could include one or more additional network termination devices at subscriber’s location 214, such as discussed below with respect to FIG. 17. Each of network termination device 218 and network termination device 220 is configured to communicatively interface devices at subscriber’s location 214 with access communication network 204. In some embodiments, each of network termination device 218 and network termination device 220 is a respective cable modem, a respective optical network (ONU), a respective optical network termination (ONT), a respective cellular wireless modem, or a respective satellite wireless modem. Network termination devices 218 and 220 need not be the same type of network termination device. While network termination device 218 and network termination device 220 are depicted as being separate elements, network termination device 218 and network termination device 220 could be co-packaged, such as in a customer premises equipment (CPE) gateway.

Network termination device 218 is communicatively coupled to subscriber LAG element 206 as symbolically shown by an arrow 222, and network termination device 220 is communicatively coupled to subscriber LAG element 206 as shown by an arrow 224. In some embodiments, subscriber LAG element 206 is at least partially implemented by one or more processors (not shown) executing instructions (not shown), e.g., instructions in the form of software and/or firmware, stored in one or more information stores (not shown). Subscriber LAG element 206 is communicatively coupled to one or more devices 226 at subscriber’s location 214, as symbolically shown by an arrow 228, to enable communication service provider’s network 212 to provide communication service to devices 226, such as to communicatively couple devices 226 to external network resources 208. Examples of devices 226 include, but are not limited to, one or more of a switch, a router, a Wi-Fi wireless access point, a mobile phone, a computer, a set-top device, a data storage device, an Internet of Things (IoT) device, an entertainment device, a computer networking device, a smartwatch, a wearable device with wireless capability, a medical device, a security device, a monitoring device, etc.

In some embodiments, the communicative coupling represented by arrow 222 represents an Ethernet cable connected between (i) an Ethernet port (not shown) of network termination device 218 and (ii) an Ethernet port (not shown) of subscriber LAG element 206. Similarly, in some embodiments the communicative coupling represented by arrow 224 represents an Ethernet cable connected between (i) an Ethernet port (not shown) of network termination device 220 and (ii) an Ethernet port (not shown) of subscriber LAG element 206. However, the communicative coupling represented by arrows 222 and 224 could be other types of communicative coupling, such as wireless communicative coupling. Additionally, while subscriber LAG element 206 is depicted as being separate from network termination device 218 and network termination device 220, in some embodiments, subscriber LAG element 206 is combined with one or both of network termination device 218 and network termination device 220. In these embodiments, the communicative coupling represented by one or both arrows 222 and 224 could represent, for example, circuitry on a printed circuit board (PCB) hosting subscriber LAG element 206 and one or both of network termination device 218 and network termination device 220, or a software communication structure in a computing device implementing subscriber LAG element 206 and one or both of network termination device 218 and network termination device 220.

Furthermore, while subscriber LAG element 206 is depicted as being separate from devices 226, in some embodiments, subscriber LAG element 206 is partially or fully integrated with one or more devices 226. For example, in certain embodiments, subscriber LAG element 206 is implemented by a switch, router, or gateway including at least two Ethernet ports. As another example, in some embodiments, subscriber LAG element 206 is implemented by a computer including at least two Ethernet ports.

Core communication network 202 includes a provider LAG element 230, which is upstream of each of access communication network 204, network termination device 218, network termination device 220, and subscriber LAG element 206. Core communication network 202 will include additional elements that are not shown for illustrative clarity, and these additional elements will vary according to the type of core communication network 202. In some embodiments, provider LAG element 230 is at least partially implemented by one or more processors (not shown) executing instructions (not shown), e.g., instructions in the form of software and/or firmware, stored in one or more information stores (not shown). In some alternate embodiments, provider LAG element 230 is upstream of core communication network 202 instead of being part of core communication network 202. For example, in certain alternate embodiments, provider LAG element 230 is included in external network resources 208 instead of being part of core communication network 202, or provider LAG element 230 is logically located between core communication network 202 and external network resources 208. In some other alternate embodiments, provider LAG element 230 is part of access communication network 204 instead of being part of core communication network 202. Subscriber LAG element 206, access communication network 204, and provider LAG element 230 collectively implement an embodiment of the new systems for network termination device aggregation by transmitting data associated with subscriber’s location 214 via a respective logical network link for each network termination device 218 and 220, as discussed below.

Communication service provider’s network 212 is configured to provision communication resources of access communication network 204 to each of network termination device 218 and network termination device 220. The type of provisioned communication resources will depend on the configuration of access communication network 204. For example, in embodiments where access communication network 204 is a cable access communication network, frequency ranges of access communication network 204, e.g., as represented by channels or other means, are provisioned to network termination device 218 and network termination device 220. As another example, in embodiments where access communication network 204 is a passive optical network, wavelength ranges of access communication network 204 are provisioned to network termination device 218 and network termination device 220.

Importantly, each of network termination device 218 and network termination device 220 is provisioned different respective communication resources of access communication network 204 to enable subscriber’s location 214 to access a greater portion of access communication network 204’s capacity than would be feasible if network termination devices 218 and 220 were provisioned common communication resources of access communication network 204. For example, assume that an embodiment of access communication network 204 is capable of supporting eight channels and that each of network termination device 218 and network termination device 220 is capable of supporting four channels. In this embodiment, communication service provider’s network 212 may be configured to provision each of network termination device 218 and network termination device 220 a different respective four channels of access communication network 204, thereby enabling devices at subscriber’s location 214 to access all eight channels of access communication network 204 via network termination devices 218 and 220.

Provider LAG element 230, access communication network 204, and subscriber LAG element 206 are collectively configured to establish logical network links 232 and 234 for network termination device 218 and network termination device 220, respectively, where each logical network link 232 and 234 spans access communication network 204 and communicatively couples subscriber LAG element 206 with provider LAG element 230. Logical network link 232 includes network termination device 218, and logical network link 234 includes network termination device 220. Logical network link 232 is logically isolated from logical network link 234. While not required, in some embodiments, each of logical network link 232 and logical network link 234 is a respective virtual private network link.

Subscriber LAG element 206 and provider LAG element 230 are each configured to perform link aggregation. Specifically, provider LAG element 230 splits downlink communication traffic destined for subscriber’s location 214 into a separate downlink data flow for each logical network link 232 and 234, and each logical network link 232 and 234 carries its respective downlink data flow from provider LAG element 230 to subscriber LAG element 206. Subscriber LAG element 206 aggregates respective downlink data flows received from logical network link 232 and logical network link 234 for use by devices 226. Additionally, subscriber LAG element 206 splits uplink communication traffic from devices 226 into a separate uplink data flow for each logical network link 232 and 234, and each logical network link 232 and 234 carries its respective uplink data flow from subscriber LAG element 206 to provider LAG element 230. Provider LAG element 230 aggregates respective uplink data flows received from logical network link 232 and logical network link 234, such as for transmission to external network resources 208. It should be noted that network termination device 218 and/or network termination device 220 may also be configured to perform link aggregation such that there are two tiers of link aggregation in communication environment 200, i.e., (i) a first tier characterized by each of network termination device 218 and network termination device 220 performing internal link aggregation and (ii) a second tier characterized by the link aggregation collectively performed by subscriber LAG element 206 and provider LAG element 230.

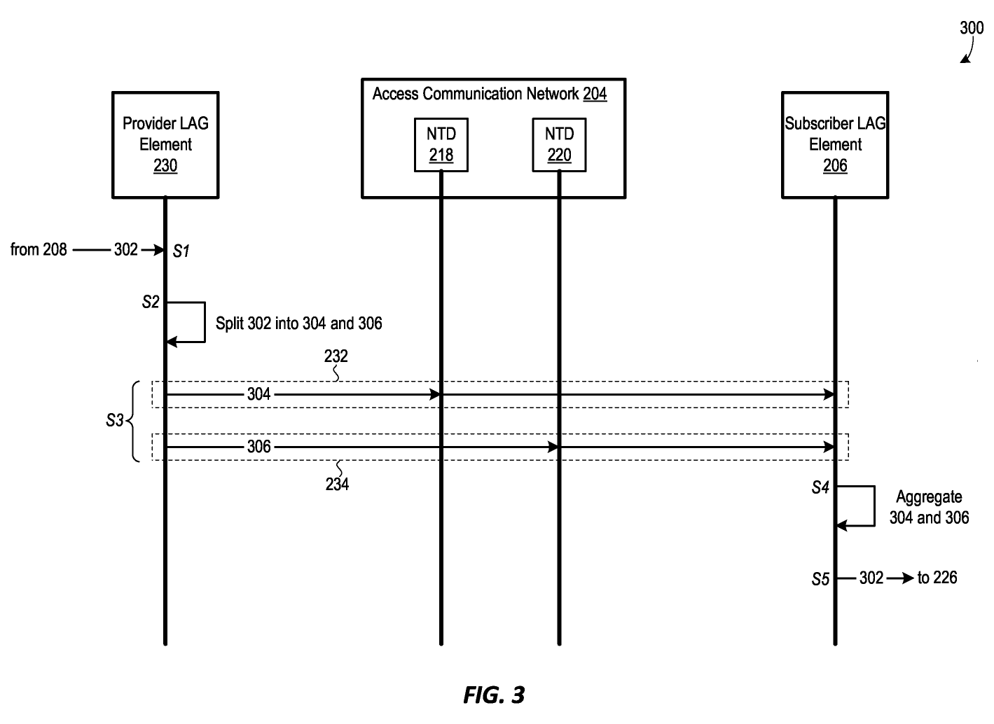

FIG. 3 is a data flow diagram 300 illustrating one example of downlink data flow in communication environment 200. Data flow diagram 300 includes vertical lines logically representing each of provider LAG element 230, network termination device 218 of access communication network 204, network termination device 220 of access communication network 204, and subscriber LAG element 206. In a step S1 of data flow diagram 300, provider LAG element 230 receives downlink communication traffic 302 from external network resources 208, where downlink communication traffic 302 is destined for subscriber’s location 214 (not shown in FIG. 3). In a step S2 of data flow diagram 300, provider LAG element 230 splits downlink communication traffic 302 into a first downlink data flow 304 and a second downlink data flow 306. In a step S3 of data flow diagram 300, logical network link 232 transmits first downlink data flow 304 from provider LAG element 230 to subscriber LAG element 206, and logical network link 234 transmits second downlink data flow 306 from provider LAG element 230 to subscriber LAG element 206. As illustrated in FIG. 3, first downlink data flow 304 travels through network termination device 218, and second downlink data flow 306 travels through network termination device 220. In a step S4 of data flow diagram 300, subscriber LAG element 206 aggregates first downlink data flow 304 and second downlink data flow 306 to obtain downlink communication traffic 302, and in step S5 of data flow diagram 300, subscriber LAG element 206 sends downlink communication traffic 302 to one or more devices 226. It should be appreciated that provisioning network termination device 218 and network termination device 220 different respective communication resources of access communication network 204 enables parallel transmission of first downlink data flow 304 and second downlink data flow 306 by access communication network 204.

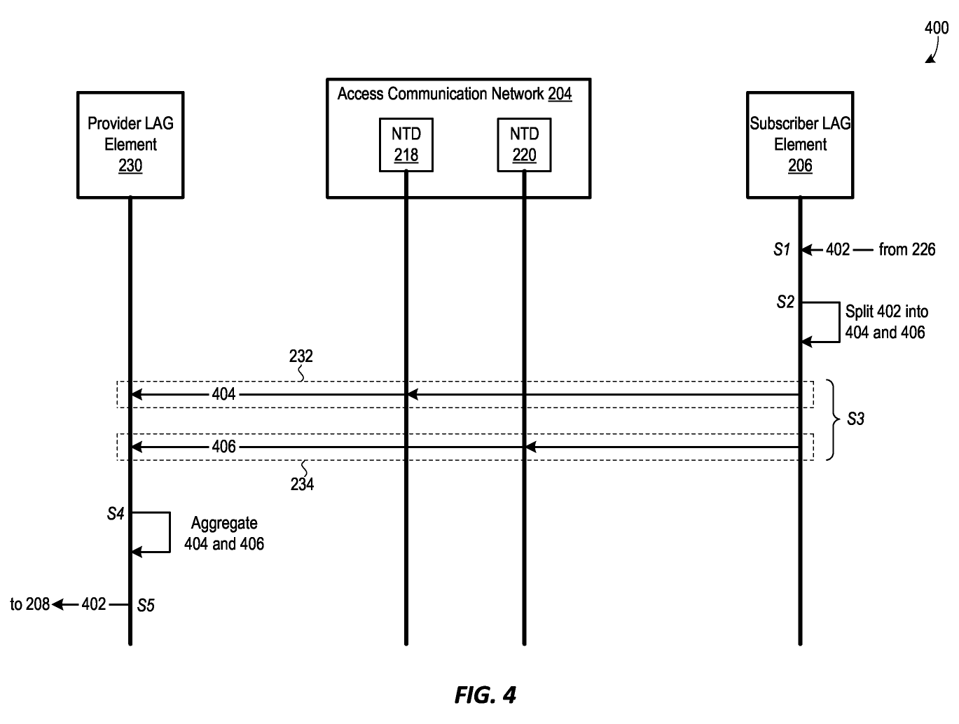

FIG. 4 is a data flow diagram 400 illustrating one example of uplink data flow in communication environment 200. Data flow diagram 400 includes vertical lines logically representing each of provider LAG element 230, network termination device 218 of access communication network 204, network termination device 220 of access communication network 204, and subscriber LAG element 206. In a step S1 of data flow diagram 400, subscriber LAG element 206 receives uplink communication traffic 402 from one or more devices 226, where uplink communication traffic 402 is destined for external network resources 208. In a step S2 of data flow diagram 400, subscriber LAG element 206 splits uplink communication traffic 402 into a first uplink data flow 404 and a second uplink data flow 406. In a step S3 of data flow diagram 400, logical network link 232 transmits first uplink data flow 404 from subscriber LAG element 206 to provider LAG element 230, and logical network link 234 transmits second uplink data flow 406 from subscriber LAG element 206 to provider LAG element 230. As illustrated in FIG. 4, first uplink data flow 404 travels through network termination device 218, and second uplink data flow 406 travels through network termination device 220. In a step S4 of data flow diagram 400, provider LAG element 230 aggregates first uplink data flow 404 and second uplink data flow 406 to obtain uplink communication traffic 402, and in step S5 of data flow diagram 400, provider LAG element 230 sends uplink communication traffic 402 to external network resources 208. It should be appreciated that provisioning network termination device 218 and network termination device 220 different respective communication resources of access communication network 204 enables parallel transmission of first uplink data flow 404 and second uplink data flow 406 by access communication network 204.

Referring again to FIG. 2, in certain embodiments, respective data flows carried by logical network link 232 and logical network link 234 are Layer-2 data flows, i.e., they are each a series of Layer-2 data frames. For example, in some embodiments, respective data flows carried by logical network link 232 and logical network link 234 are Ethernet data flows, i.e., they are each a series of Ethernet data frames. Configuration of logical network link 232 and logical network link 234 to carry Layer-2 data flows preserves original MAC addresses, any virtual local area network (VLAN) tags of data frames, Layer-2 broadcast domains, and provides flexibility in selection of Layer-3 communication protocols of logical network link 232 and logical network link 234. Additionally, configuration of logical network link 232 and logical network link 234 to carry Layer-2 data flows does not interfere with Layer-3 routing, thereby enabling a subscriber to handle routing of their communication traffic if desired.

While configuring logical network link 232 and logical network link 234 to carry Layer-2 data flows may achieve significant advantages as discussed above, use of higher communication protocols with logical network link 232 and logical network link 234 may also realize advantages, such as ability to steer traffic between logical network link 232 and logical network link 234 and/or ability to implement policy-based routing to dynamically optimize data flows. Accordingly, in some other embodiments, logical network link 232 and logical network link 234 operate at a layer other than Layer-2. For example, in some embodiments, logical network link 232 and logical network link 234 operate according to Multiprotocol Layer Switching (MPLS), which is a communication protocol that directs data packets over a network using labels instead of using network addresses, to realize scalable and secure data pathways. MPLS operates between Layer-2 and Layer-3, and MPLS is sometimes referred to as a “Layer-2.5” communication protocol. As another example, in some embodiments, logical network link 232 and logical network link 234 operate according to Multipath TCP (MP-TCP), which is a Layer-4 communication protocol allowing a Transmission Control Protocol (TCP) connection to use multiple paths. As an additional example, in particular embodiments, logical network link 232 and logical network link 234 operate according to Multi-path QUIC (MP-QUIC), which is a Layer-4 communication protocol that is an extension of the QUIC communication protocol enabling hosts to exchange data over multiple networks which logically appear as a single connection. The QUIC (Quick User Datagram Protocol Internet Connections) communication protocol, in turn, is a communication protocol that is intended to replace TCP and improve performance of web applications. As a further example, in particular embodiments, logical network link 232 and logical network link 234 operate according to a Stream Control Transmission Protocol (SCTP) which is a Layer-4 communication protocol that ensures reliable data delivery between two endpoints. SCTP is used, for example, to transmit messages over unreliable connectionless networks, such as a network operating according to an Internet Protocol (IP). In some embodiments, logical network link 232 and logical network link 234 operate according to multiple communication protocols, such as according to both of MP-TCP and MP-QUIC.

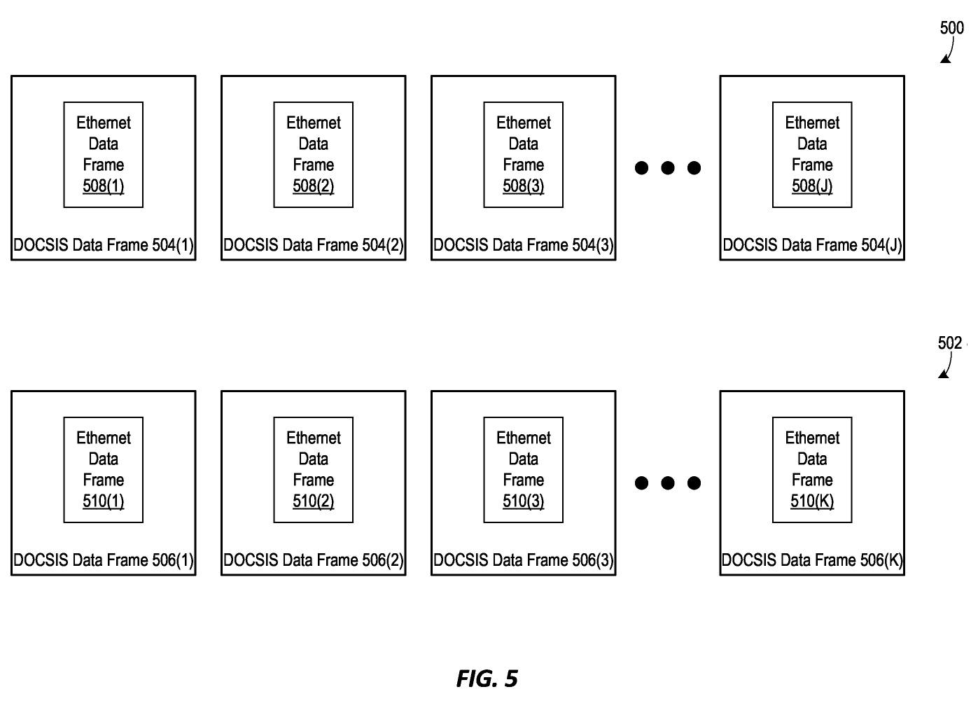

The communication protocol used for logical network link 232 and logical network link 234 will typically be different from an underlying communication protocol used by access communication network 204. As such, data structures carried by logical network link 232 and logical network link 234 will typically be encapsulated by data structures of access communication network 204. For example, FIG. 5 depicts two Layer-2 data flows in an embodiment of communication environment 200 where (i) access communication network 204 is a cable communication network operating according to a DOCSIS communication protocol and (ii) each of logical network link 232 and logical network link 234 operates according to an Ethernet communication protocol, resulting in there being one DOCSIS media access control (MAC) domain and two Ethernet MAC domains supported by communication service provider’s network 212 when serving subscriber’s location 214. FIG. 5 depicts an example Layer-2 data flow 500 carried by logical network link 232 and an example Layer-2 data flow 502 carried by logical network link 234. Layer-2 data flow 500 includes a series of J DOCSIS data frames 504, where J is an integer greater than 3, and Layer-2 data flow 502 includes a series of K DOCSIS data frames 506, where K is an integer greater than 3. In this document, specific instances of an item may be referred to by use of a numeral in parentheses (e.g. DOCSIS data frame 504(1)) while numerals without parentheses refer to any such item (e.g. DOCSIS data frames 504). Each DOCSIS data frame 504 includes a respective Ethernet data frame 508 encapsulated therein, or stated different, each Ethernet data frame 508 is encapsulated within a respective DOCSIS data frame 504, where Ethernet data frames 508 are Layer-2 data frames carried by logical network link 232. Similarly, each DOCSIS data frame 506 includes a respective Ethernet data frame 510 encapsulated therein, or stated differently, each Ethernet data frame 510 is encapsulated within a respective DOCSIS data frame 506, where Ethernet data frames 510 are Layer-2 data frames carried by logical network link 234.

It should be noted that FIG. 5 could be adapted to embodiments where access communication network 204 operates according to a communication protocol other than a DOCSIS communication protocol. For example, in embodiments where access communication network 204 operates according to a PON communication protocol, DOCSIS data frames 504 would be replaced with PON data frames including Ethernet data frames 508 encapsulated therein, and DOCSIS data frames 506 would be replaced with PON data frames including Ethernet data frames 510 encapsulated therein. As another example, in embodiments where access communication network 204 operates according to a 3GPP communication protocol, DOCSIS data frames 504 would be replaced with 3GPP data frames including Ethernet data frames 508 encapsulated therein, and DOCSIS data frames 506 would be replaced with 3GPP data frames including Ethernet data frames 510 encapsulated therein.

Referring again to FIG. 2, in particular embodiments, subscriber LAG element 206 and/or provider LAG element 230 control logical network link 232 and logical network link 234 at least partially using a Link Aggregation Control Protocol (LACP), e.g., an Institute of Electrical and Electronics Engineers (IEEE) 802.1AX communication protocol or a successor thereof, such as to negotiate, create, and/or manage logical network link 232 and logical network link 234. In these embodiments, the LACP combines respective physical Ethernet links corresponding to network termination device 218 and network termination device 220 into one logical link called a link aggregation group or a port channel. Use of LACP in place of static link aggregation advantageously enables communication environment 200 to adapt to differences in capacity between logical network link 232 and logical network link 234. Additionally, use of LACP may enable continuity of communication service at subscriber’s location 214 if one of logical network links 232 and 234 goes off-line, such as due to one of network termination device 218 and network termination device 220 rebooting. Furthermore, subscriber LAG element 206 and/or provider LAG element 230 may use LACP to balance loads of logical network link 232 and logical network link 234, such as according to logical network link capacity and/or stability, by controlling split of communication traffic between logical network link 232 and logical network link 234.

Additionally, in some embodiments where logical network link 232 and logical network link 234 operate according to a Layer-2 communication protocol, subscriber LAG element 206 and/or provider LAG element 230 are configured to implement mechanisms to limit packet loss and jitter. For example, some embodiments of subscriber LAG element 206 and/or provider LAG element 230 implement jitter buffers to stabilize packet delivery, and certain embodiments of subscriber LAG element 206 and/or provider LAG element 230 use adaptive traffic shaping and load balancing, such as on a flow basis, to manage unstable logical network links 232 and/or 234. As another example, particular embodiments of subscriber LAG element 206 and/or 230 use error correction and retransmission strategies with logical network links 232 and 234 to reduce packet loss, thereby helping reduce latency by minimizing need for retransmission which increases latency. As a further example, some embodiments of provider LAG element 230 and subscriber LAG element 206 adjust traffic policies, such as policies for splitting communication traffic between logical network link 232 and logical network link 234, to minimize latency differences between the two logical network links, thereby enhancing performance of access communication network 204 when providing communication service to subscriber’s location 214.

Furthermore, certain embodiments of subscriber LAG element 206 and/or provider LAG element 230 are configured to perform extended monitoring. For example, some embodiments of subscriber LAG element 206 and/or provider LAG element 230 associate data flows with specific network termination devices 218 and 220 during logical network link aggregation, thereby allowing subscriber LAG element 206 and/or provider LAG element 230 to track individual performance of network termination device 218 and network termination device 220. As another example, in particular embodiments, subscriber LAG element 206 and/or provider LAG element 230 extend monitoring to evaluate data flows after their aggregation, thereby enabling subscriber LAG element 206 and/or provider LAG element 230 to identify discrepancies between logical network links 232 and 234, such as excessive packet loss on a particular logical network link 232 or 234 or reduced utilization of a specific logical network link 232 or 234.

Moreover, some embodiments of subscriber LAG element 206 and/or provider LAG element 230 are configured to perform traffic flow analysis. For example, certain embodiments of subscriber LAG element 206 and/or provider LAG element 230 continuously analyze communication traffic patterns across logical network link 232 and logical network link 234 to detect data transmission inefficiencies or instability. As another example, some embodiments of logical network link 232 and/or logical network link 234 use diagnostic tools to identify issues with logical network link 232 and logical network link 234, such as high latency, packet loss, and/or interference, thereby facilitating targeted troubleshooting.

Additionally, particular embodiments of provider LAG element 230 and/or subscriber LAG element 206 are configured to implement feedback loop mechanisms for controlling logical network links 232 and 234. For instance, some embodiments of subscriber LAG element 206 and/or provider LAG element 230 are configured to monitor data flowing through logical network link 232 and logical network link 234 and control network termination device 218 and network termination device 220 to dynamically adjust splitting of communication traffic between logical network links 232 and 234. For example, some embodiments prioritize use of a less utilized logical network link 232 or 234 or use of a more stable logical network link 232 or 234 to improve overall data transmission efficiency before using a higher contention logical network link 232 or 234. As another example, certain embodiments respond to fluctuations in network conditions, such as by adjusting splitting of communication traffic among logical network links 232 and 234 to adapt to changes in logical network link utilization and/or interference level.

Furthermore, certain embodiments of subscriber LAG element 206 and/or provider LAG element 230 are configured to implement one or more data transmission optimization strategies. For example, some embodiments of subscriber LAG element 206 and/or provider LAG element 230 use real time data associated with logical network links 232 and 234 to guide traffic shaping decisions, such as to help ensure balanced load distribution among logical network links. As another example, some embodiments of subscriber LAG element 206 and/or provider LAG element 230 proactively manage logical network link 232 and 234 capacities to maintain optimal data transmission performance, such as by leveraging data on logical network link conditions to enhance data transmission reliability and speed.

Moreover, some embodiments of subscriber LAG element 206 and/or provider LAG element 230 are configured to help resolve any issues with logical network links 232 and 234 that should arise. For example, certain embodiments of subscriber LAG element 206 and/or provider LAG element 230 integrate automated alerts and/or reports to notify network administrators of emerging issues with logical network link 232 or 234, thereby helping ensure prompt intervention. As another example, particular embodiments of subscriber LAG element 206 and/or provider LAG element 230 facilitate issue preemption by continuously refining configurations of logical network link 232 and logical network link 234 to adapt to evolving data transmission demands.

FIG. 6 is a block diagram of a communication environment 600 which is an embodiment of communication environment 200 (FIG. 2) where communication service provider’s network 212 is embodied by a cable communication service provider’s network 612. Core communication network 202 of FIG. 2 is embodied by a cable core communication network 602 in FIG. 6, and access communication network 204 of FIG. 2 is embodied by a cable access communication network 604 in FIG. 6. Details of cable core communication network 602 are not shown for illustrative clarity, but in some embodiments, cable core communication network 602 includes one or more of a router, a core switch, a server, broadband network gateway (BNG), and an access gateway function (AGF). While provider LAG element 230 is depicted as being a stand-alone element in cable core communication network 602, provider LAG element 230 could alternately be combined with one or more other elements of cable core communication network 602, such as with a BNG or an AGF. Additionally, in certain embodiments, provider LAG element 230 is part of a converged cable access platform (CCAP) 636 instead of being part of cable core communication network 602.

Cable access communication network 604 includes CCAP 636, a communication medium 638 (e.g., a fiber optic cable, a 10G Ethernet cable, or a direct attach copper (DAC) cable), a remote PHY device (RPD), a coaxial cable plant 642, a cable modem (CM) 618, and a cable modem 620. Cable modem 618 is an embodiment of network termination device 218 (FIG. 2), and cable modem 620 is an embodiment of network termination device 220 (FIG. 2). Communication medium 638 communicatively couples RPD with CCAP 636, and coaxial cable plant 642 includes one or more coaxial cables communicatively coupling cable modems 618 and 620 with RPD 640. Coaxial cable plant 642 may also include additional elements, such as one or more amplifiers, taps, and/or power inserters. In some alternate embodiments, (i) CCAP is replaced with a cable modem termination system (CMTS) or other device with analogous functionality and (ii) RPD 640 is replaced with a fiber node. In certain embodiments, cable access communication network 604 operates according to a DOCSIS communication protocol.

CCAP 636 provisions each of cable modem 618 and cable modem 620, for example, by sending respective profiles to each cable modem 618 and 620. CCAP 636 provisions each cable modem 618 and 620 different respective frequency ranges of coaxial cable plant 642, such as different respective channel sets of coaxial cable plant 642, either in a common MAC domain or across multiple MAC domains, to increase capacity of cable access communication network 604 available for use at subscriber’s location 214. Some embodiments of CCAP 636 test two or more profiles on cable modems 618 and 620 before sending a final set of profiles to cable modems 618 and 620, such as to help provision cables modems 618 and 620 in a manner that maximizes capacity of cable access communication network 604 available at subscriber’s location 214. In some embodiments, CCAP 636 is configured to provision cable modem 618 and cable modem 620 with identical quality of service (QoS) settings, such as identical queue configurations. In some other embodiments, CCAP 636 is configured to provision cable modem 618 differently from cable modem 620, such as by providing unique service flows and selectors for each cable modem 618 and 620, to leverage differences among cable modems 618 and 620 and/or their respective operating environments. For example, cable modem 618 could be provisioned in a manner that optimizes it for low latency communication traffic while cable modem 620 could be provisioned in a manner that optimizes it for high throughput data rates. In cases where cable modems 618 and 620 are provisioned so that each cable modem 618 and 620 is optimized for a different characteristic, customer premises equipment downstream of cable modems 618 and 620 would need to be aware of these different optimizations, or be able to detect these different optimizations, to be able to route communication traffic to cable modems 618 and 620 in a manner which exploits the respective optimizations of cable modems 618 and 620.

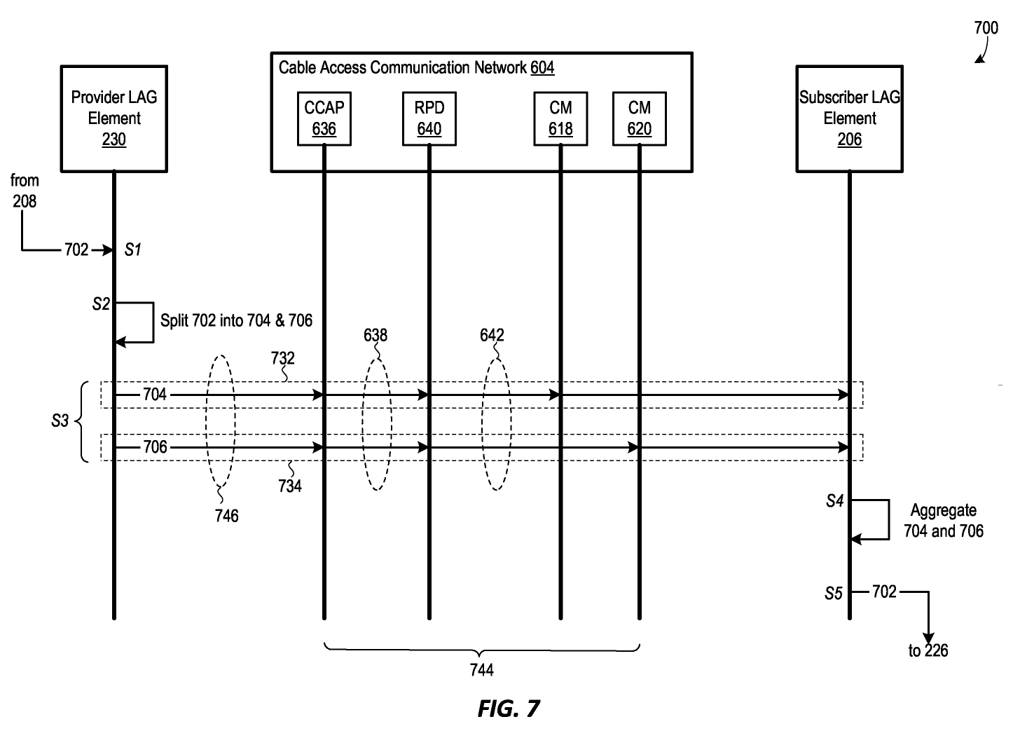

FIG. 7 is a data flow diagram 700 illustrating one example of downlink data flow in communication environment 600. Data flow diagram 700 includes vertical lines logically representing each of provider LAG element 230, CCAP 636, RPD 640, cable modem 618, cable modem 620, and subscriber LAG element 206. Cable communication service provider’s network 612 establishes a logical network link 732 and a logical network link 734, where logical network link 732 and logical network link 734 are embodiments of logical network link 232 (FIG. 2) and logical network link 234 (FIG. 2), respectively. Additionally, CCAP 636 optionally implements a portion 744 of logical network link 732 and logical network link 734 between CCAP 636 and cable modems 618 and 620 using a L2VPN (Layer 2 Virtual Private Network) specification. The L2VPN specification is a DOCSIS specification that enables a cable communication service provider to establish Layer-2 logically isolated paths, sometimes referred to as pseudo wires, between cable modems and a CCAP or an analogous device. Certain embodiments of CCAP 636 use the L2VPN to control split of communication traffic between logical network link 732 and logical network link 734 in a manner which helps minimize differences in latency between logical network link 732 and logical network link 734. For example, if latency of logical network link 732 increases significantly relative to latency of logical network link 734, CCAP 636, or one or more additional elements of cable communication service provider’s network 612, may shift a portion of communication traffic handled by logical network link 732 to logical network link 734 to help restore uniform latency among to the two logical network links.

In a step S1 of data flow diagram 700, provider LAG element 230 receives downlink communication traffic 702 from external network resources 208, where downlink communication traffic 702 is destined for subscriber’s location 214 (not shown in FIG. 7). In a step S2 of data flow diagram 700, provider LAG element 230 splits downlink communication traffic 702 into a first downlink data flow 704 and a second downlink data flow 706. In a step S3 of data flow diagram 700, logical network link 732 transmits first downlink data flow 704 from provider LAG element 230 to subscriber LAG element 206, and logical network link 734 transmits second downlink data flow 706 from provider LAG element 230 to subscriber LAG element 206. Specifically, transmission of first downlink data flow 704 via logical network link 732 includes (i) transmission of first downlink data flow 704 from provider LAG element 230 to CCAP 636, (ii) transmission of first downlink data flow 704 from CCAP 636 to RPD 640 via communication medium 638, (iii) transmission of first downlink data flow 704 from RPD 640 to cable modem 618 via coaxial cable plant 642, and (iv) transmission of first downlink data flow 704 from cable modem 618 to subscriber LAG element 206. Similarly, transmission of second downlink data flow 706 via logical network link 734 includes (i) transmission of second downlink data flow 706 from provider LAG element 230 to CCAP 636, (ii) transmission of second downlink data flow 706 from CCAP 636 to RPD 640 via communication medium 638, (iii) transmission of second downlink data flow 706 from RPD 640 to cable modem 620 via coaxial cable plant 642, and (iv) transmission of second downlink data flow 706 from cable modem 620 to subscriber LAG element 206.

In some embodiments, each of first downlink data flow 704 and second downlink data flow 706 are trunked via a common physical communication medium 746, e.g., a common fiber optic cable, between provider LAG element 230 and CCAP 636. In some embodiments, first downlink data flow 704 and second downlink data flow 706 comply with one of an IEEE 802.1Q communication protocol, an IEEE 802.1ad communication protocol, an MPLS communication protocol, and a Point-to-Point Protocol over Ethernet (PPPoE) communication protocol, while being trunked via common physical communication medium 746.

In a step S4 of data flow diagram 700, subscriber LAG element 206 aggregates first downlink data flow 704 and second downlink data flow 706 to obtain downlink communication traffic 702, and in step S5 of data flow diagram 700, subscriber LAG element 206 sends downlink communication traffic 702 to one or more devices 226. It should be appreciated that provisioning cable modem 618 and cable modem 620 different respective frequency ranges of coaxial cable plant 642 enables parallel transmission of first downlink data flow 704 and second downlink data flow 706 by cable access communication network 642.

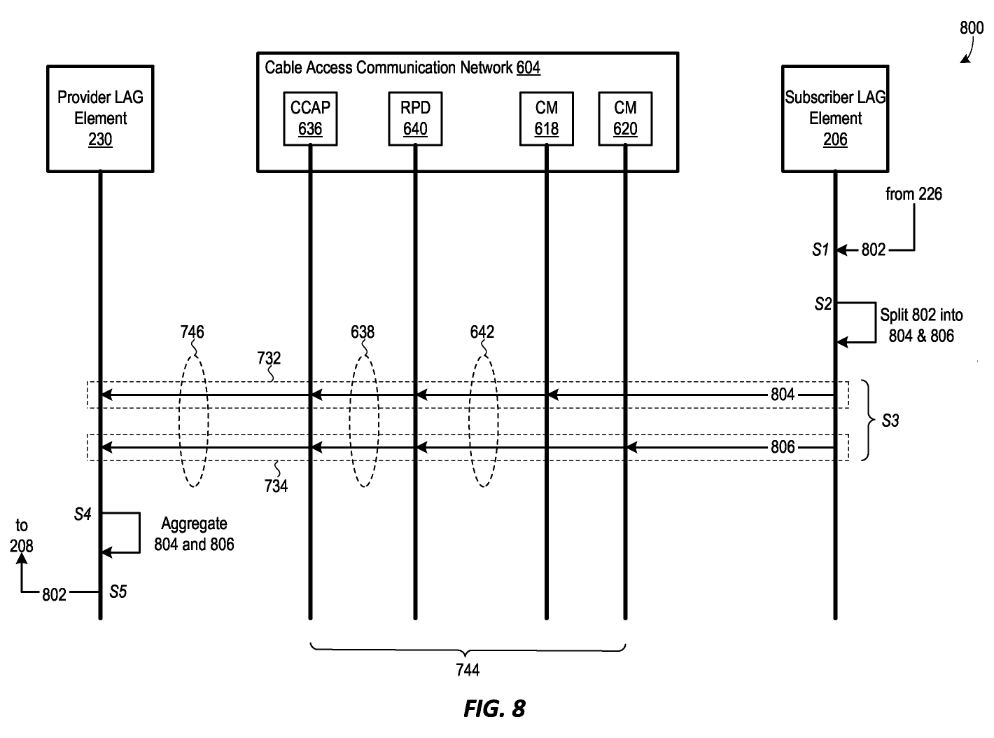

FIG. 8 is a data flow diagram 800 illustrating one example of uplink data flow in communication environment 600. Data flow diagram 800 includes vertical lines logically representing each of provider LAG element 230, CCAP 636, RPD 640, cable modem 618, cable modem 620, and subscriber LAG element 206. FIG. 8 additionally illustrates logical network link 732 and logical network link 734, and as discussed above with respect to FIG. 7, CCAP 636 optionally implement portion 744 of logical network link 732 and logical network link 734 between CCAP 636 and cable modems 618 and 620 using a L2VPN specification.

In a step S1 of data flow diagram 800, subscriber LAG element 206 receives uplink communication traffic 802 from one or more devices 226, where uplink communication traffic 802 is destined for external network resources 208. In a step S2 of data flow diagram 800, subscriber LAG element 206 splits uplink communication traffic 802 into a first uplink data flow 804 and a second uplink data flow 806. In a step S3 of data flow diagram 800, logical network link 732 transmits first uplink data flow 804 from subscriber LAG element 206 to provider LAG element 230, and logical network link 734 transmits second uplink data flow 806 from subscriber LAG element 206 to provider LAG element 230. Specifically, transmission of first uplink data flow 804 via logical network link 732 includes (i) transmission of first uplink data flow 804 from subscriber LAG element 206 to cable modem 618, (ii) transmission of first uplink data flow 804 from cable modem 618 to RPD 640 via coaxial cable plant 642, (iii) transmission of first uplink data flow 804 from RPD 640 to CCAP 636 via communication medium 638, and (iv) transmission of first uplink data flow 804 from CCAP 636 to provider LAG element 230. Similarly, transmission of second uplink data flow 806 via logical network link 734 includes (i) transmission of second uplink data flow 806 from subscriber LAG element 206 to cable modem 620, (ii) transmission of second uplink data flow 806 from cable modem 620 to RPD 640 via coaxial cable plant 642, (iii) transmission of second uplink data flow 806 from RPD 640 to CCAP 636 via communication medium 638, and (iv) transmission of second uplink data flow 806 from CCAP 636 to provider LAG element 230.

In a manner similar to that discussed above with respect to FIG. 7, in some embodiments, each of first uplink data flow 804 and second uplink data flow 806 is trunked via common physical communication medium 746 between provider LAG element 230 and CCAP 636. In some embodiments, first uplink data flow 804 and second uplink data flow 806 comply with one of an IEEE 802.1Q communication protocol, an IEEE 802.1ad communication protocol, an MPLS communication protocol, and a PPPoE communication protocol, while being transmitted via common physical communication medium 746.

In a step S4 of data flow diagram 800, provider LAG element 230 aggregates first uplink data flow 804 and second uplink data flow 806 to obtain uplink communication traffic 802, and in step S5 of data flow diagram 800, provider LAG element 230 sends uplink communication traffic 802 to external network resources 208. It should be appreciated that provisioning cable modem 618 and cable modem 620 different respective frequency ranges of coaxial cable plant 642 enables parallel transmission of first uplink data flow 804 and second uplink data flow 806 by cable access communication network 642.

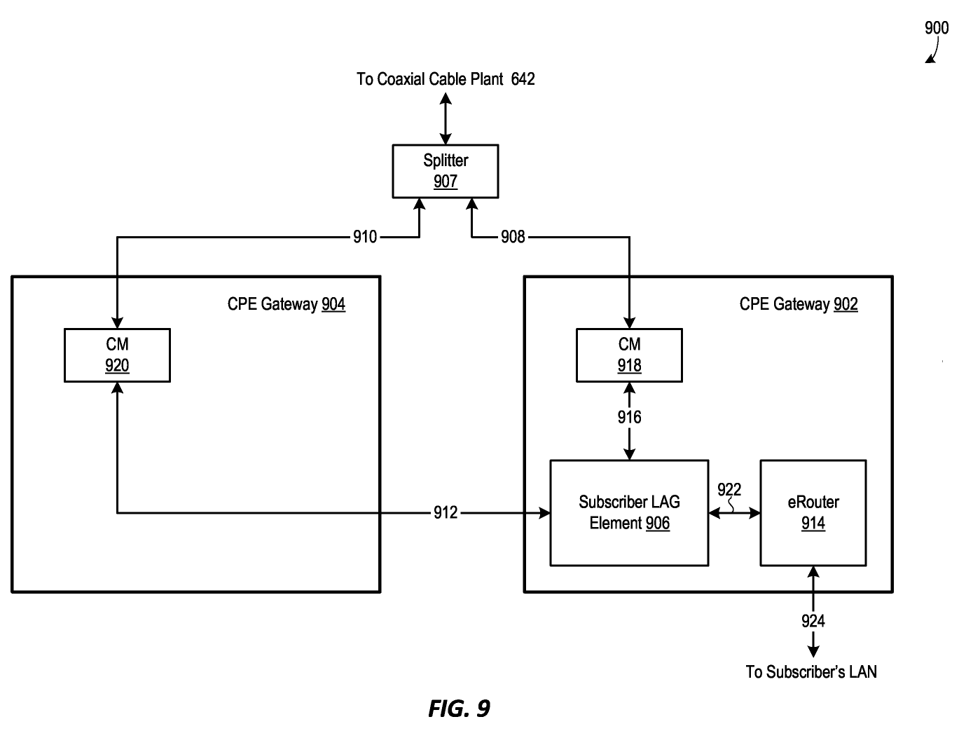

FIG. 9 is a block diagram 900 illustrating one example implementation of cable modem 618, cable modem 620, and subscriber LAG element 206 of communication environment 600 (FIG. 6). FIG. 9 includes a CPE gateway 902, a CPE gateway 904, a splitter 907, a coaxial cable 908, a coaxial cable 910, and an Ethernet cable 912 (e.g., an electrical Ethernet cable or an optical Ethernet cable). CPE gateway 902 includes a cable modem 918, a subscriber LAG element 906, and an eRouter 914, where (i) cable modem 918 is an embodiment of cable modem 618 (FIG. 6) and (ii) subscriber LAG element 906 is an embodiment of subscriber LAG element 206 (FIG. 6). Cable modem 918 is communicatively coupled to subscriber LAG element 906 as symbolically shown by an arrow 916, subscriber LAG element 906 is communicatively coupled to eRouter 914 as symbolically shown by an arrow 922, and eRouter 914 is communicatively coupled to a subscriber’s LAN as symbolically shown by an arrow 924. eRouter 914 handles routing of communication traffic between the subscriber’s LAN and CPE gateway 902. In some embodiments, CPE gateway 902 is at least partially implemented by one or more processors (not shown) executing instructions (not shown), e.g., instructions in the form of software and/or firmware, stored in one or more information stores (not shown).

CPE gateway 904 includes a cable modem 920, which is an embodiment of cable modem 620 (FIG. 6). In some embodiments, CPE gateway 904 is at least partially implemented by one or more processors (not shown) executing instructions (not shown), e.g., instructions in the form of software and/or firmware, stored in one or more information stores (not shown). Additionally, in certain embodiments, CPE gateway 902 and CPE gateway 904 have the same hardware configuration while having different firmware configurations, such as to promote use of standard hardware at subscribers’ locations. For example, in some embodiments, (i) CPE gateway 902 and CPE gateway 904 have the same hardware configuration, (ii) CPE gateway 902 includes firmware implementing subscriber LAG element 906 and eRouter 914 along with cable modem 918, and (iii) CPE gateway 904 includes firmware implementing solely cable modem 920.

Splitter 907 communicatively couples cable modem 918 and cable modem 920 with coaxial cable plant 642 via coaxial cable 908 and coaxial cable 910, respectively. Additionally, Ethernet cable 912 communicatively couples subscriber LAG element 906 with cable modem 920. CPE gateway 902 serves as a primary gateway that handles link aggregation and routing, as well as handles communication with cable access communication network 604 (not pictured) via cable modem 918. CPE gateway 904, on the other hand, is a secondary gateway that is configured to supplement the capacity of CPE gateway 902.

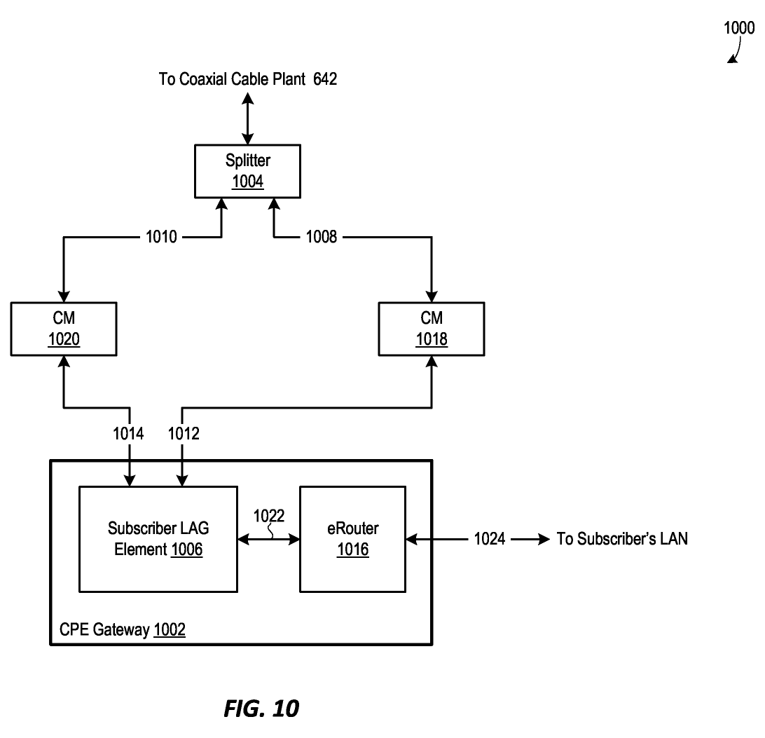

FIG. 10 is a block diagram 1000 illustrating another example implementation of cable modem 618, cable modem 620, and subscriber LAG element 206 of communication environment 600 (FIG. 6). FIG. 10 includes a CPE gateway 1002, a cable modem 1018, a cable modem 1020, a splitter 1004, a coaxial cable 1008, a coaxial cable 1010, an Ethernet cable 1012 (e.g., an electrical Ethernet cable or an optical Ethernet cable), and an Ethernet cable 1014 (e.g., an electrical Ethernet cable or an optical Ethernet cable). Cable modem 1018 is an embodiment of cable modem 618 (FIG. 6), and cable modem 1020 is an embodiment of cable modem 620 (FIG. 6). CPE gateway 1002 includes a subscriber LAG element 1006 and an eRouter 1016, wherein subscriber LAG element 1006 is an embodiment of subscriber LAG element 206 (FIG. 6). Splitter 1004 communicatively couples cable modem 1018 and cable modem 1020 with coaxial cable plant 642 via coaxial cable 1008 and coaxial cable 1010, respectively. Subscriber LAG element 1006 is communicatively coupled with cable modem 1018 via Ethernet cable 1012, and subscriber LAG element 1006 is communicatively coupled with cable modem 1020 via Ethernet cable 1014. Subscriber LAG element 1006 is communicatively coupled with eRouter 1016, as symbolically shown by an arrow 1022. eRouter 1016 is communicatively coupled with a subscriber’s LAN, as symbolically shown by an arrow 1024, and eRouter 1016 handles routing of communication traffic between the subscriber’s LAN and CPE gateway 1002. In some embodiments, CPE gateway 1002 is at least partially implemented by one or more processors (not shown) executing instructions (not shown), e.g., instructions in the form of software and/or firmware, stored in one or more information stores (not shown).

FIG. 11 is a block diagram of a communication environment 1100 which is an embodiment of communication environment 200 (FIG. 2) where communication service provider’s network 212 is embodied by a PON communication service provider’s network 1112. Core communication network 202 of FIG. 2 is embodied by a PON core communication network 1102 in FIG. 11, and access communication network 204 of FIG. 2 is embodied by a PON access communication network 1104 in FIG. 11. Details of PON core communication network 1102 are not shown for illustrative clarity, but in some embodiments, PON core communication network 1102 includes one or more of a router, a core switch, and a server. While provider LAG element 230 is depicted as being a stand-alone element in PON core communication network 1102, provider LAG element 230 could alternately be combined with one or more other elements of PON core communication network 1102. Additionally, provider LAG element 230 could be combined with an optical line terminal (OLT) 1136 (discussed below) of PON access communication network 1104 instead of being within PON core communication network 1102.

PON access communication network 1114 includes an OLT 1136, an optical fiber plant 1138, an ONT 1118, and an ONT 1120. ONT 1118 is an embodiment of network termination device 218 (FIG. 2), and ONT 1120 is an embodiment of network termination device 220 (FIG. 2). In some alternate embodiments, each of ONT 1118 and ONT 1120 is replaced with a respective ONU. Optical fiber plant 1138 communicatively couples ONT 1118 and ONT 1120 with OLT 1136. Optical fiber plant 1138 includes one or more optical fibers, and optical fiber plant 1138 may also include additional elements, such as optical splitters. In certain embodiments, PON access communication network 1104 operates according to a PON communication protocol, such as an EPON communication protocol, a GPON communication protocol, an XG-PON communication protocol, an XGS-PON communication protocol, an NG-PON2 communication protocol, a CPON communication protocol, or a successor of any of the aforementioned communication protocols. OLT 1136 provisions each of ONT 1118 and 1120 different respective wavelength ranges of optical fiber plant 1138 to increase capacity of PON access communication network 1104 available for use at subscriber’s location 214.

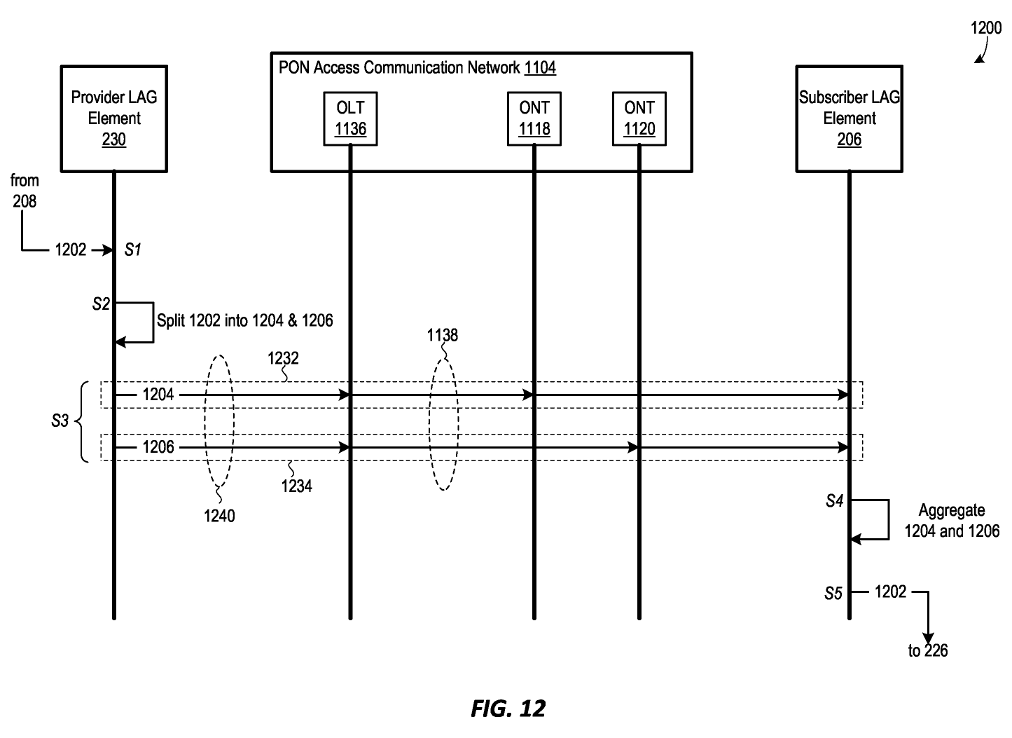

FIG. 12 is a data flow diagram 1200 illustrating one example of downlink data flow in communication environment 1100. Data flow diagram 1200 includes vertical lines logically representing each of provider LAG element 230, OLT 1136, ONT 1118, ONT 1120, and subscriber LAG element 206. PON communication service provider’s network 1112 establishes a logical network link 1232 and logical network link 1234, where logical network link 1232 and logical network link 1234 are embodiments of logical network link 232 (FIG. 2) and logical network link 234 (FIG. 2), respectively.

In a step S1 of data flow diagram 1200, provider LAG element 230 receives downlink communication traffic 1202 from external network resources 208, where downlink communication traffic 1202 is destined for subscriber’s location 214 (not shown in FIG. 12). In a step S2 of data flow diagram 1200, provider LAG element 230 splits downlink communication traffic 1202 into a first downlink data flow 1204 and a second downlink data flow 1206. In a step S3 of data flow diagram 1200, logical network link 1232 transmits first downlink data flow 1204 from provider LAG element 230 to subscriber LAG element 206, and logical network link 1234 transmits second downlink data flow 1206 from provider LAG element 230 to subscriber LAG element 206. Specifically, transmission of first downlink data flow 1204 via logical network link 1232 includes (i) transmission of first downlink data flow 1204 from provider LAG element 230 to OLT 1136, (ii) transmission of first downlink data flow 1204 from OLT 1136 to ONT 1118 via optical fiber plant 1138, and (iii) transmission of first downlink data flow 1204 from ONT 1118 to subscriber LAG element 206. Similarly, transmission of second downlink data flow 1206 via logical network link 1234 includes (i) transmission of second downlink data flow 1206 from provider LAG element 230 to OLT 1136, (ii) transmission of second downlink data flow 1206 from OLT 1136 to ONT 1120 via optical fiber plant 1138, and (iii) transmission of second downlink data flow 1206 from ONT 1120 to subscriber LAG element 206.

In some embodiments, each of first downlink data flow 1204 and second downlink data flow 1206 is trunked via a common physical communication medium 1240, e.g., a common fiber optic cable, between provider LAG element 230 and OLT 1136. In some embodiments, first downlink data flow 1204 and second downlink data flow 1206 comply with one of an IEEE 802.1Q communication protocol, an IEEE 802.1ad communication protocol, an MPLS communication protocol, and a PPPoE communication protocol, while being trunked via common physical communication medium 1240.

In a step S4 of data flow diagram 1200, subscriber LAG element 206 aggregates first downlink data flow 1204 and second downlink data flow 1206 to obtain downlink communication traffic 1202, and in step S5 of data flow diagram 1200, subscriber LAG element 206 sends downlink communication traffic 1202 to one or more devices 226. It should be appreciated that provisioning ONT 1118 and ONT 1120 different respective wavelength ranges of optical fiber plant 1138 enables parallel transmission of first downlink data flow 1204 and second downlink data flow 1206 by optical fiber plant 1138. Uplink data flow in communication environment 1100 is not illustrated, but is understood that uplink data flow in communication environment 1100 may be analogous to that illustrated in data flow diagram 1200 but in the reverse direction where provider LAG element 230 and subscriber LAG element 206 swap roles, i.e., provider LAG element 230 aggregates data flows and subscriber LAG element 206 splits data flows.

FIG. 13 is a block diagram of a communication environment 1300 which is an embodiment of communication environment 200 (FIG. 2) where communication service provider’s network 212 is embodied by a cellular communication service provider’s network 1312. Core communication network 202 of FIG. 2 is embodied by a cellular core communication network 1302 in FIG. 13, and access communication network 204 of FIG. 2 is embodied by a cellular access communication network 1304 in FIG. 13. Details of cellular core communication network 1302 are not shown for illustrative clarity, but in some embodiments, cellular core communication network 1302 includes elements of a 3GPP core communication network. While provider LAG element 230 is depicted as being a stand-alone element in cellular core communication network 1302, provider LAG element 230 could alternately be combined with one or more other elements of cellular core communication network 1302, e.g., with a user plane function (UPF) of cellular core communication network 1302. Additionally, provider LAG element 230 could be combined with an element of cellular access communication network 1304 instead of being part of cellular core communication network 1302.

Cellular access communication network 1304 includes a cellular wireless base station 1336, a cellular wireless base station 1338, and a cellular wireless base station 1340, although it is realized that the quantity of cellular wireless base stations of cellular access communication network 1304 may vary. For example, cellular access communication network 1304 may include many cellular wireless base stations distributed over a large geographic area. In some embodiments, the wireless base stations of cellular access communication network 1304 are part of a RAN operating according to a 3GPP communication protocol.

Cellular access communication network 1304 further includes a cellular wireless modem (CWM) 1318 and a cellular wireless modem 1320. Cellular wireless modem 1318 is an embodiment of network termination device 218 (FIG. 2), and cellular wireless modem 1320 is an embodiment of network termination device 220 (FIG. 2). Cellular provider’s network 1312 provisions each of cellular wireless modem 1318 and cellular wireless modem 1320 different respective communication resources of cellular access communication network 1304 to increase capacity of cellular access communication network 1304 available for use at subscriber’s location 214. For example, in certain embodiments, each of cellular wireless modem 1318 and cellular wireless modem 1320 are provisioned different respective communication resources of a common cellular wireless base station, such as different frequency resources of the cellular wireless base station, different time resources of the cellular wireless base station, different antenna resources of the cellular wireless base station, and different power resources of the cellular wireless base station. As another example, in some embodiments, each of cellular wireless modem 1318 and cellular wireless modem 1320 is provisioned communication resources of a different respective cellular wireless base station. For instance, cellular wireless modem 1318 could be provisioned communication resources of cellular wireless base station 1336 while cellular wireless modem 1320 is provisioned communication resources of cellular wireless base station 1340.

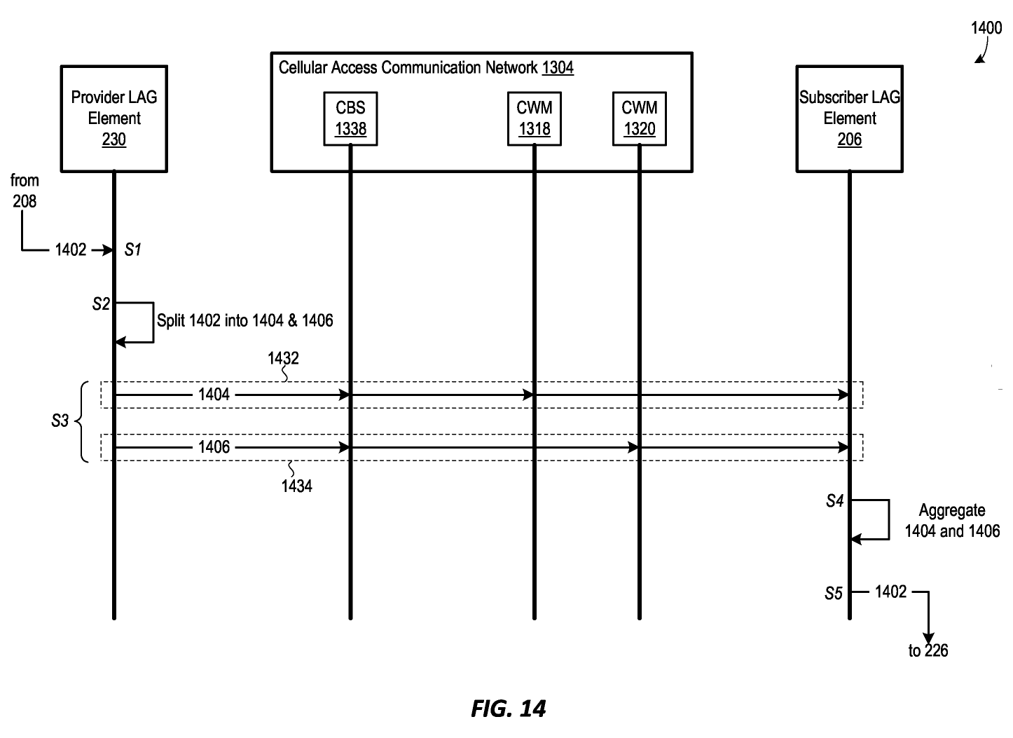

FIG. 14 is a data flow diagram 1400 illustrating one example of downlink data flow in communication environment 1300. Data flow diagram 1400 includes vertical lines logically representing each of provider LAG element 230, cellular base station (CBS) 1338, cellular wireless modem 1318, cellular wireless modem 1320, and subscriber LAG element 206, and data flow diagram 1400 assumes that cellular wireless modem 1318 and cellular wireless modem 1320 are provisioned different respective communication resources of cellular wireless base station 1338. Cellular communication service provider’s network 1312 establishes a logical network link 1432 and logical network link 1434, where logical network link 1432 and logical network link 1434 are embodiments of logical network link 232 (FIG. 2) and logical network link 234 (FIG. 2), respectively.

In a step S1 of data flow diagram 1400, provider LAG element 230 receives downlink communication traffic 1402 from external network resources 208, where downlink communication traffic 1402 is destined for subscriber’s location 214 (not shown in FIG. 14). In a step S2 of data flow diagram 1400, provider LAG element 230 splits downlink communication traffic 1402 into a first downlink data flow 1404 and a second downlink data flow 1406. In a step S3 of data flow diagram 1400, logical network link 1432 transmits first downlink data flow 1404 from provider LAG element 230 to subscriber LAG element 206, and logical network link 1434 transmits second downlink data flow 1406 from provider LAG element 230 to subscriber LAG element 206. Specifically, transmission of first downlink data flow 1404 via logical network link 1432 includes (i) transmission of first downlink data flow 1404 from provider LAG element 230 to cellular wireless base station 1338, (ii) transmission of first downlink data flow 1404 from cellular wireless base station 1338 to cellular wireless modem 1318, and (iii) transmission of first downlink data flow 1404 from cellular wireless modem 1318 to subscriber LAG element 206. Similarly, transmission of second downlink data flow 1406 via logical network link 1434 includes (i) transmission of second downlink data flow 1406 from provider LAG element 230 to cellular wireless base station 1338, (ii) transmission of second downlink data flow 1406 from cellular wireless base station 1338 to cellular wireless modem 1320, and (iii) transmission of second downlink data flow 1406 from cellular wireless modem 1320 to subscriber LAG element 206.

In a step S4 of data flow diagram 1400, subscriber LAG element 206 aggregates first downlink data flow 1404 and second downlink data flow 1406 to obtain downlink communication traffic 1402, and in step S5 of data flow diagram 1400, subscriber LAG element 206 sends downlink communication traffic 1402 to one or more devices 226. It should be appreciated that provisioning cellular wireless modem 1318 and cellular wireless modem 1320 different respective communication resources of cellular access communication network 1304 enables parallel transmission of first downlink data flow 1404 and second downlink data flow 1406 by cellular access communication network 1304. Uplink data flow in communication environment 1300 is not illustrated, but is understood that uplink data flow in communication environment 1300 may be analogous to that illustrated in data flow diagram 1400 but in the reverse direction where provider LAG element 230 and subscriber LAG element 206 swap roles, i.e., provider LAG element 230 aggregates data flows and subscriber LAG element 206 splits data flows.

FIG. 15 is a block diagram of a communication environment 1500 which is an embodiment of communication environment 200 (FIG. 2) where communication service provider’s network 212 is embodied by a satellite communication service provider’s network 1512. Core communication network 202 of FIG. 2 is embodied by a satellite core communication network 1502 in FIG. 15, and access communication network 204 of FIG. 2 is embodied by a satellite access communication network 1504 in FIG. 15. Details of satellite core communication network 1502 are not shown for illustrative clarity. While provider LAG element 230 is depicted as being a stand-alone element in satellite core communication network 1502, provider LAG element 230 could alternately be combined with one or more other elements of satellite core communication network 1502. Additionally, provider LAG element 230 could be combined with an element of satellite access communication network 1504 instead of being part of satellite core communication network 1502.

Satellite access communication network 1504 includes a satellite 1536, a satellite 1538, a satellite 1540, and a ground station 1542, although it is realized that the quantity of satellites and ground stations of satellite access communication network 1504 may vary. For example, satellite access communication network 1504 may include a large quantity of satellites orbiting the earth as well as a significant quantity of ground stations in different respective regions of the earth. In some embodiments, the satellites of satellite access communication network 1504 are very low earth orbit (VLEO) satellites, low earth orbit (LEO) satellites, medium earth orbit (MEO) satellites, or geostationary equatorial orbit (GEO) satellites.

Satellite access communication network 1504 further includes a satellite wireless modem (SWM) 1518 and a satellite wireless modem 1520. Satellite wireless modem 1518 is an embodiment of network termination device 218 (FIG. 2), and satellite wireless modem 1520 is an embodiment of network termination device 220 (FIG. 2). Each of satellite wireless modem 1518 and satellite wireless modem 1520 wirelessly communicates with one or more of satellite 1536, satellite 1538, and satellite 1540. Additionally, each of satellite 1536, satellite 1538, and satellite 1540 wirelessly communicates with ground station 1542, and ground station 1542 communicatively couples each of the aforementioned satellites with satellite core communication network 1502 via one or more wireline and/or wireless communication links (not shown).

Satellite provider’s communication network 1512 provisions each of satellite wireless modem 1518 and satellite wireless modem 1520 different respective communication resources of satellite access communication network 1504 to increase capacity of satellite access communication network 1504 available for use at subscriber’s location 214. For example, in certain embodiments, each of satellite wireless modem 1518 and satellite wireless modem 1520 are provisioned different respective communication resources of a common satellite, such as different frequency resources of the satellite, different time resources of the satellite, different antenna resources of the satellite, and different power resources of the satellite. As another example, in some embodiments, each of satellite wireless modem 1518 and satellite wireless modem 1520 is provisioned communication resources of a different respective satellite. For instance, satellite wireless modem 1518 could be provisioned communication resources of satellite 1536 while satellite wireless modem 1520 is provisioned communication resources of satellite 1540.

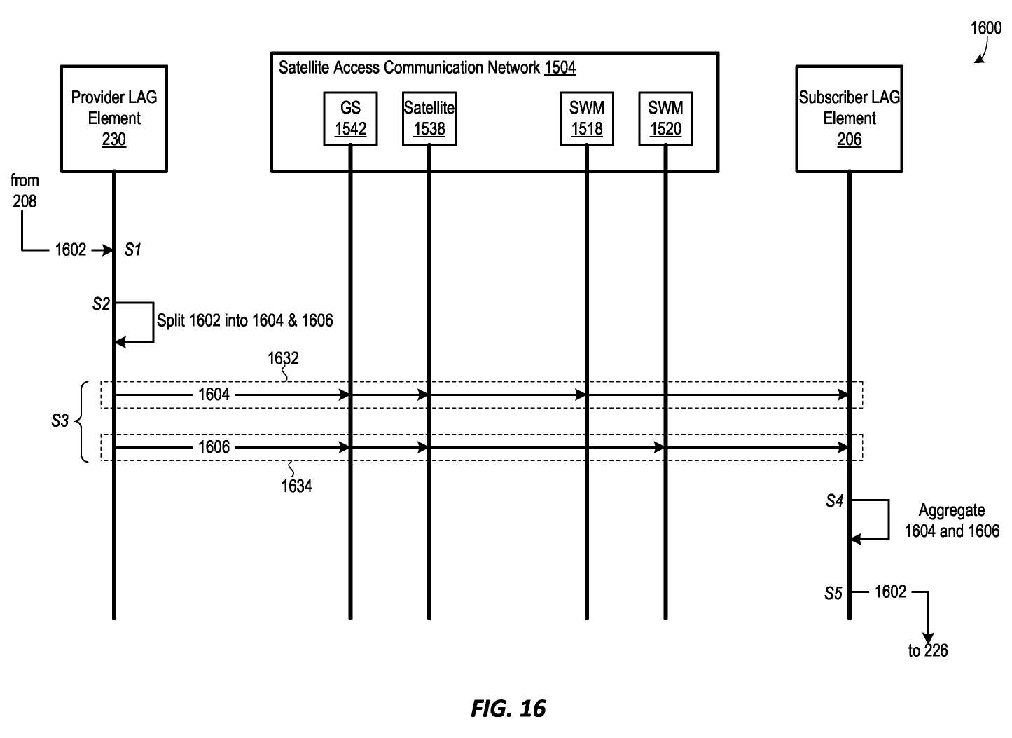

FIG. 16 is a data flow diagram 1600 illustrating one example of downlink data flow in communication environment 1500. Data flow diagram 1600 includes vertical lines logically representing each of provider LAG element 230, ground station (GS) 1542, satellite 1538, satellite wireless modem 1518, satellite wireless modem 1520, and subscriber LAG element 206, and data flow diagram 1600 assumes that satellite wireless modem 1518 and satellite wireless modem 1520 are provisioned different respective communication resources of satellite 1538. Satellite communication service provider’s network 1512 establishes a logical network link 1632 and a logical network link 1634, where logical network link 1632 and logical network link 1634 are embodiments of logical network link 232 (FIG. 2) and logical network link 234 (FIG. 2), respectively.

In a step S1 of data flow diagram 1600, provider LAG element 230 receives downlink communication traffic 1602 from external network resources 208, where downlink communication traffic 1602 is destined for subscriber’s location 214 (not shown in FIG. 16). In a step S2 of data flow diagram 1600, provider LAG element 230 splits downlink communication traffic 1602 into a first downlink data flow 1604 and a second downlink data flow 1606. In a step S3 of data flow diagram 1600, logical network link 1632 transmits first downlink data flow 1604 from provider LAG element 230 to subscriber LAG element 206, and logical network link 1634 transmits second downlink data flow 1606 from provider LAG element 230 to subscriber LAG element 206. Specifically, transmission of first downlink data flow 1604 via logical network link 1632 includes (i) transmission of first downlink data flow 1604 from provider LAG element 230 to ground station 1542, (ii) transmission of first downlink data flow 1604 from ground station 1542 to satellite 1538, (iii) transmission of first downlink data flow 1604 from satellite 1538 to satellite wireless modem 1518, and (iv) transmission of first downlink data flow 1604 from satellite wireless modem 1518 to subscriber LAG element 206. Similarly, transmission of second downlink data flow 1606 via logical network link 1634 includes (i) transmission of second downlink data flow 1606 from provider LAG element 230 to ground station 1542, (ii) transmission of second downlink data flow 1606 from ground station 1542 to satellite 1538, (iii) transmission of second downlink data flow 1606 from satellite 1538 to satellite wireless modem 1520, and (iv) transmission of second downlink data flow 1606 from satellite wireless modem 1520 to subscriber LAG element 206.

In a step S4 of data flow diagram 1600, subscriber LAG element 206 aggregates first downlink data flow 1604 and second downlink data flow 1606 to obtain downlink communication traffic 1602, and in step S5 of data flow diagram 1600, subscriber LAG element 206 sends downlink communication traffic 1602 to one or more devices 226. It should be appreciated that provisioning satellite wireless modem 1518 and satellite wireless modem 1520 different respective communication resources of satellite access communication network 1504 enables parallel transmission of first downlink data flow 1604 and second downlink data flow 1606 by satellite access communication network 1504. Uplink data flow in communication environment 1500 is not illustrated, but is understood that uplink data flow in communication environment 1500 may be analogous to that illustrated in data flow diagram 1600 but in the reverse direction where provider LAG element 230 and subscriber LAG element 206 swap roles, i.e., provider LAG element 230 aggregates data flows and subscriber LAG element 206 splits data flows.

Referring again to FIG. 2, as discussed above, access communication network 204 could be modified to include one or more additional network termination devices at subscriber’s location 214, such as to further increase capacity of access communication network 204 available at subscriber’s location 214. For example, FIG. 17 is a block diagram of a communication environment 1700, which is an alternate embodiment of communication environment 200 (FIG. 2) including an additional network termination device at subscriber’s location 214. Communication environment 1700 differs from communication environment 200 in that (i) communication service provider’s network 212 is replaced with a communication services provider’s network 1712, (ii) communication service provider’s network 1712 includes an access communication network 1704 in place of access communication network 204, and (iii) access communication network 1704 includes an additional network termination device, i.e., a network termination device 1736, at subscriber’s location 214. Network termination device 1736 is, for example, a cable modem, an ONT, an ONU, a cellular wireless modem, or a satellite wireless modem. Network termination devices 218, 220, and 1736 need not be the same type of network termination device. Network termination device 1736 is communicatively coupled to subscriber LAG element 206 as symbolically shown by an arrow 1738.

Communication service provider’s network 1712 is configured to provision different respective communication resources of access communication network 1704 to each of network termination device 218, network termination device 220, and network termination device 1736. For example, assume that an embodiment access communication network 1704 is capable of supporting nine channels and that each of network termination device 218, network termination device 220, and network termination device 1736 is capable of supporting three channels. In this embodiment, communication service provider’s network 1712 may be configured to provision each of network termination device 218, network termination device 220, and network termination device 1736 a different respective three channels of access communication network 1704, thereby enabling devices at subscriber’s location 214 to access all nine channels of access communication network 1704 via the combination network termination devices 218, 220, and 1736.

Provider LAG element 230, access communication network 1704, and subscriber LAG element 206 are collectively configured to establish logical network link 1740 for network termination device 1736, in addition to aforementioned logical network link 232 and logical network link 234. Each of logical network link 232, logical network link 234, and logical network link 1740 spans access communication network 1704 and communicatively couples subscriber LAG element 206 with provider LAG element 230. Logical network link 232 includes network termination device 218, logical network link 234 includes network termination device 220, and logical network link 1740 includes network termination device 1736. Each of logical network link 232, logical network link 234, and logical network link 1740 is logically isolated from each other of logical network link 232, logical network link 234, and logical network link 1740.

In the FIG. 17 embodiment, provider LAG element 230 splits downlink communication traffic destined for subscriber’s location 214 into a separate downlink data flow for each logical network link 232, 234, and 1740, and each logical network link 232, 234, and 1740 carries its respective downlink data flow from provider LAG element 230 to subscriber LAG element 206. Subscriber LAG element 206 aggregates respective downlink data flows received from logical network link 232, logical network link 234, and logical network link 1740 for use by devices 226. Additionally, subscriber LAG element 206 splits uplink communication traffic from devices 226 into a separate uplink data flow for each logical network link 232, 234, and 1740, and each logical network link 232, 234, and 1740 carries its respective uplink data flow from subscriber LAG element 206 to provider LAG element 230. Provider LAG element 230 aggregates respective uplink data flows received from logical network link 232, logical network link 234, and logical network link 1740, such as for transmission to external network resources 208.

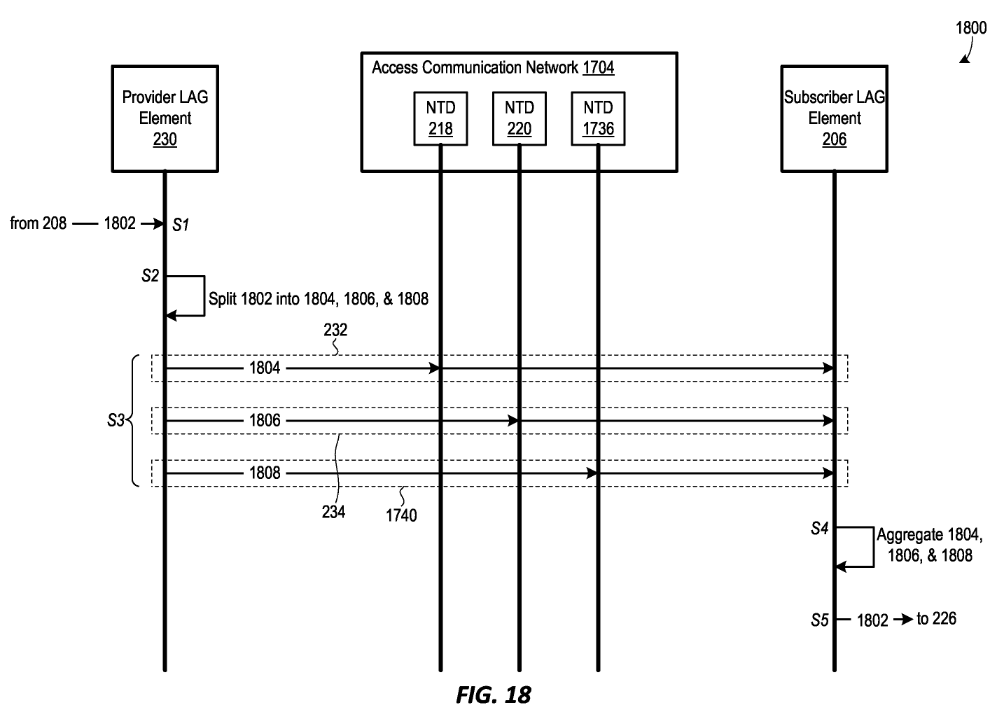

FIG. 18 is a data flow diagram 1800 illustrating one example of downlink data flow in communication environment 1700. Data flow diagram 1800 includes vertical lines logically representing each of provider LAG element 230, network termination device 218 of access communication network 1704, network termination device 220 of access communication network 1704, network termination device 1736 of access communication network 1704, and subscriber LAG element 206. In a step S1 of data flow diagram 1800, provider LAG element 230 receives downlink communication traffic 1802 from external network resources 208, where downlink communication traffic 1802 is destined for subscriber’s location 214. In a step S2 of data flow diagram 1800, provider LAG element 230 splits downlink communication traffic 1802 into a first downlink data flow 1804, a second downlink data flow 1806, and a third downlink data flow 1808. In a step S3 of data flow diagram 1800, logical network link 232 transmits first downlink data flow 1804 from provider LAG element 230 to subscriber LAG element 206, logical network link 234 transmits second downlink data flow 1806 from provider LAG element 230 to subscriber LAG element 206, and logical network link 1740 transmits third downlink data flow 1808 from provider LAG element 230 to subscriber LAG element 206. As illustrated in FIG. 18, first downlink data flow 1804 travels through network termination device 218, second downlink data flow 1806 travels through network termination device 220, and third downlink data flow 1808 travels through network termination device 1736.

In a step S4 of data flow diagram 1800, subscriber LAG element 206 aggregates first downlink data flow 1804, second downlink data flow 1806, and third downlink data flow 1808 to obtain downlink communication traffic 1802, and in step S5 of data flow diagram 1800, subscriber LAG element 206 sends downlink communication traffic 1802 to one or more devices 226. It should be appreciated that provisioning network termination device 218, network termination device 220, and network termination device 1736 different respective communication resources of access communication network 1704 enables parallel transmission of first downlink data flow 1804, second downlink data flow 1806, and third downlink data flow 1808 by access communication network 1704.

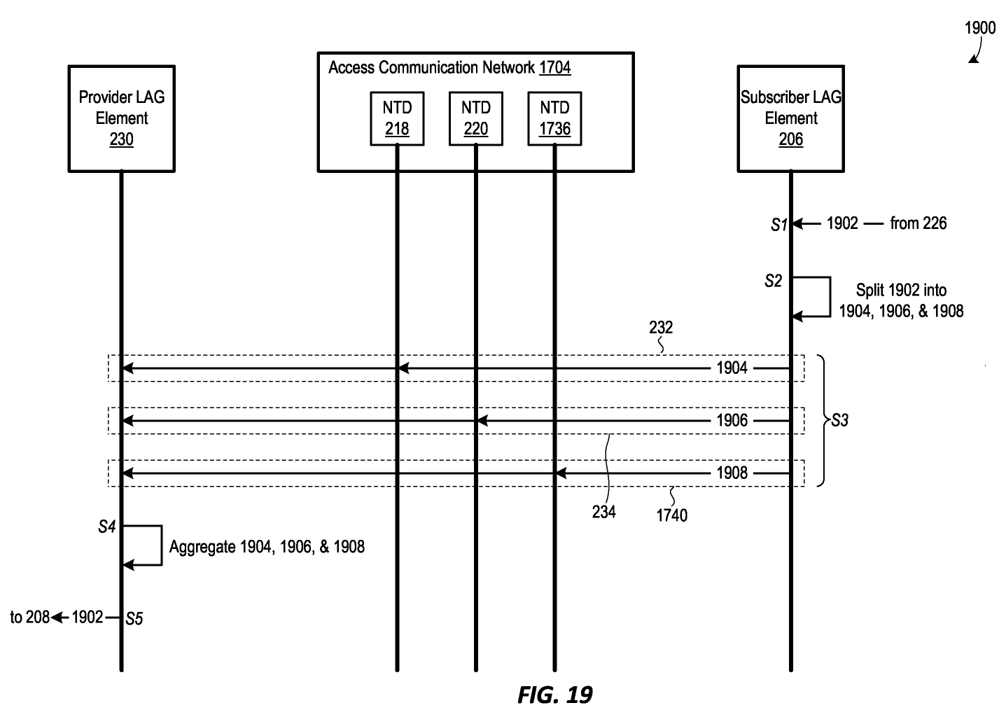

FIG. 19 is a data flow diagram 1900 illustrating one example of uplink data flow in communication environment 1700. Data flow diagram 1900 includes vertical lines logically representing each of provider LAG element 230, network termination device 218 of access communication network 1704, network termination device 220 of access communication network 1704, network termination device 1736 of access communication network 1704, and subscriber LAG element 206. In a step S1 of data flow diagram 1900, subscriber LAG element 206 receives uplink communication traffic 1902 from one or more devices 226, where uplink communication traffic 1902 is destined for external network resources 208. In a step S2 of data flow diagram 1900, subscriber LAG element 206 splits uplink communication traffic 1902 into a first uplink data flow 1904, a second uplink data flow 1906, and a third uplink data flow 1908. In a step S3 of data flow diagram 1900, logical network link 232 transmits first uplink data flow 1904 from subscriber LAG element 206 to provider LAG element 230, logical network link 234 transmits second uplink data flow 1906 from subscriber LAG element 206 to provider LAG element 230, and logical network link 1740 transmits third uplink data flow 1908 from subscriber LAG element 206 to provider LAG element 230. As illustrated in FIG. 19, first uplink data flow 1904 travels through network termination device 218, second uplink data flow 1906 travels through network termination device 220, and third uplink data flow 1908 travels through network termination device 1736.

In a step S4 of data flow diagram 1900, provider LAG element 230 aggregates first uplink data flow 1904, second uplink data flow 1906, and third uplink data flow 1908 to obtain uplink communication traffic 1902, and in step S5 of data flow diagram 1900, provider LAG element 230 sends uplink communication traffic 1902 to external network resources 208. It should be appreciated that provisioning network termination device 218, network termination device 220, and network termination device 1736 different respective communication resources of access communication network 1704 enables parallel transmission of first uplink data flow 1904, second uplink data flow 1906, and third uplink data flow 1908 by access communication network 1704.

### Combinations of Features

Features described above may be combined in various ways without departing from the scope hereof. The following examples illustrate some possible combinations.

(A1) A method for network termination device aggregation includes (i) provisioning a first network termination device at a subscriber’s location to use first communication resources of an access communication network, (ii) provisioning a second network termination device at the subscriber's location to use second communication resources of the access communication network, the second communication resources of the access communication network being different from the first communication resources of the access communication network, (iii) at a provider link aggregation element, splitting downlink communication traffic destined for the subscriber’s location into at least a first downlink data flow and a second downlink data flow, (iv) transmitting the first downlink data flow to a subscriber link aggregation element via a first logical network link, the first logical network link including the first network termination device and communicatively coupling the subscriber link aggregation element with the provider link aggregation element, and (v) transmitting the second downlink data flow to the subscriber link aggregation element via a second logical network link, the second logical network link including the second network termination device and communicatively coupling the subscriber link aggregation element with the provider link aggregation element.

(A2) In the method denoted as (A1), each of the first downlink data flow and the second downlink data flow may be a respective Layer-2 downlink data flow.

(A3) In the method denoted as (A1), (i) each of the first downlink data flow and the second downlink data flow may be a respective Ethernet downlink data flow and (ii) the access communication network may operate according to one or more of a Data Over Cable Service Interface Specification (DOCSIS) communication protocol, a passive optical network (PON) communication protocol, a cellular wireless communication protocol, and a satellite wireless communication protocol.

(A4) In the method denoted as (A1), each of the first downlink data flow and the second downlink data flow may be one of (i) a Multiprotocol Layer Switching (MPLS) downlink data flow, (ii) a Multipath Transmission Control Protocol (MP-TCP) downlink data flow, (iii) a Multi-path Quick User Datagram Protocol Internet Connections (MP-QUIC) downlink data flow, and (iv) a Stream Control Transmission Protocol (SCTP) downlink data flow.

(A5) Any one of the methods denoted as (A1) through (A4) may further include aggregating the first downlink data flow and the second downlink data flow at the subscriber link aggregation element.

(A6) Any one of the methods denoted as (A1) through (A5) may further include (i) transmitting a first uplink data flow from the subscriber link aggregation element to the provider link aggregation element via the first logical network link, (ii) transmitting a second uplink data flow from the subscriber link aggregation element to the provider link aggregation element via the second logical network link, and (iii) aggregating the first uplink data flow and the second uplink data flow at the provider link aggregation element.

(A7) Any one of the methods denoted as (A1) through (A6) may further include controlling each of the first logical network link and the second logical network link at least partially using a control protocol.

(A8) In the method denoted as (A7), the control protocol may be a link aggregation control protocol (LACP).

(A9) Any one of the methods denoted as (A1) through (A8) may further include transmitting each of the first downlink data flow and the second downlink data flow from the provider link aggregation element to the access communication network according to one of an Institute of Electrical and Electronics Engineers (IEEE) 802.1Q communication protocol, an IEEE 802.1ad communication protocol, a multiprotocol label switching (MPLS) communication protocol, and a Point-to-Point Protocol over Ethernet (PPPoE) communication protocol.

(A10) In any one of the methods denoted as (A1) through (A9), (i) the access communication network may be a cable communication network operating according to a Data Over Cable Service Interface Specification (DOCSIS) communication protocol, (ii) the first network termination device may be a first cable modem, and (iii) the second network termination device may be a second cable modem.

(A11) In the method denoted as (A10), each of the first logical network link and the second logical network link may comply with a DOCSIS L2VPN specification.

(A12) In any one of the methods denoted as (A1) through (A11), (i) the access communication network may include a coaxial cable plant, (ii) the first communication resources of the access communication network may include one or more first frequency ranges of the coaxial cable plant, and (iii) the second communication resources of the access communication network may include one or more second frequency ranges of the coaxial cable plant.

(A13) In any one of the methods denoted as (A1) through (A9), (i) the access communication network may be a passive optical network (PON), (ii) the first network termination device may be one of a first optical network unit (ONU) and a first optical network termination (ONT), and (iii) the second network termination device may be one of a second ONU and a second ONT.

(A14) In any one of the methods denoted as (A1) through (A9), as well as in the method denoted as (A13), (i) the access communication network may include an optical fiber plant, (ii) the first communication resources of the access communication network may include one or more first wavelength ranges of the optical fiber plant, and (iii) the second communication resources of the access communication network may include one or more second wavelength ranges of the optical fiber plant.

(A15) In any one the methods denoted as (A1) through (A9), (i) the access communication network may be a cellular wireless communication network operating according to a Third Generation Partnership Project (3GPP) communication protocol, (ii) the first network termination device may be a first cellular wireless modem, and (iii) the second network termination device may be a second cellular wireless modem.

(A16) In any one of the methods denoted as (A1) through (A9), as well as in the method denoted as (A15), (1) the access communication network may include a cellular wireless base station, (2) the first communication resources of the access communication network may include one or more of (i) a first set of frequency resources of the cellular wireless base station, (ii) a first set of time resources of the cellular wireless base station, (iii) a first set of antenna resources of the cellular wireless base station, and (iv) a first set of power resources of the cellular wireless base station, and (3) the second communication resources of the access communication network may include one or more of (i) a second set of frequency resources of the cellular wireless base station, (ii) a second set of time resources of the cellular wireless base station, (iii) a second set of antenna resources of the cellular wireless base station, and (iv) a second set of power resources of the cellular wireless base station.

(A17) In any one of the methods denoted as (A1) through (A9), as well as in the method denoted as (A15), (i) the access communication network may include a first cellular wireless base station and a second cellular wireless base station, (ii) the first communication resources of the access communication network may include communication resources of the first cellular wireless base station, and (iii) the second communication resources of the access communication network may include communication resources of second cellular wireless base station.

(A18) In any one of the methods denoted as (A1) through (A9), (i) the access communication network may be a satellite wireless communication network, (ii) the first network termination device may be a first satellite wireless modem, and (iii) the second network termination device may be a second satellite wireless modem.

(A19) In any one of the methods denoted as (A1) through (A9), as well as in the method denoted as (A18), (1) the access communication network may include a satellite, (2) the first communication resources of the access communication network may include one or more of (i) a first set of frequency resources of the satellite, (ii) a first set of time resources of the satellite, (iii) a first set of antenna resources of the satellite, and (iv) a first set of power resources of the satellite, and (3) the second communication resources of the access communication network may include one or more of (i) a second set of frequency resources of the satellite, (ii) a second set of time resources of the satellite, (iii) a second set of antenna resources of the satellite, and (iv) a second set of power resources of the satellite.

(A20) In any one of the methods denoted as (A1) through (A9), as well as in the method denoted as (A18), (i) the access communication network may include a first satellite and a second satellite, (ii) the first communication resources of the access communication network may include communication resources of the first satellite, and (iii) the second communication resources of the access communication network may include communication resources of the second satellite.

(A21) Any one of the methods denoted as (A1) through (A20) may further include (i) provisioning a third network termination device at the subscriber's location to use third communication resources of the access communication network, the third communication resources of the access communication network being different from the first communication resources of the access communication network and the second communication resources of the access communication network, (ii) at the provider link aggregation element, splitting the downlink communication traffic destined for the subscriber’s location into a third downlink data flow as well as the first downlink data flow and the second downlink data flow, and (iii) transmitting the third downlink data flow to the subscriber link aggregation element via a third logical network link, the third logical network link including the third network termination device and communicatively coupling the subscriber link aggregation element with the provider link aggregation element.

(A22) In any one of the methods denoted as (A1) through (A21), each of the first downlink data flow and the second downlink data flow may be a respective Ethernet downlink data flow, and the access communication network may operate according to two or more of the following communication protocols: (i) a Data Over Cable Service Interface Specification (DOCSIS) communication protocol, (ii) a passive optical network (PON) communication protocol, (iii) a cellular wireless communication protocol, and (iv) a satellite wireless communication protocol.

(B1) A method for network termination device aggregation includes (i) at a subscriber link aggregation element, splitting uplink communication traffic into at least a first uplink data flow and a second uplink data flow, (ii) sending the first uplink data flow to a provider link aggregation element via a first logical network link, the first logical network link including a first network termination device and communicatively coupling the subscriber link aggregation element with the provider link aggregation element, the first network termination device being located at a subscriber’s location and being provisioned first communication resources of an access communication network, and (iii) sending the second uplink data flow to the provider link aggregation element via a second logical network link, the second logical network link including a second network termination device and communicatively coupling the subscriber link aggregation element with the provider link aggregation element, the second network termination device being located at the subscriber’s location and being provisioned second communication resources of the access communication network, the second communication resources of the access communication network being different from the first communication resources of the access communication network.

(B2) In the method denoted as (B1), each of the first uplink data flow and the second uplink data flow may be a respective Layer-2 uplink data flow.

(B3) In the method denoted as (B1), each of the first uplink data flow and the second uplink data flow may be a respective Ethernet uplink data flow, and the access communication network may operate according to one or more of (i) a Data Over Cable Service Interface Specification (DOCSIS) communication protocol, (ii) a passive optical network (PON) communication protocol, (iii) a cellular wireless communication protocol, and (iv) a satellite wireless communication protocol

(B4) In the method denoted as (B1), each of the first uplink data flow and the second uplink data flow may be one of (i) a Multiprotocol Layer Switching (MPLS) uplink data flow, (ii) a Multipath Transmission Control Protocol (MP-TCP) uplink data flow, (iii) a Multi-path Quick User Datagram Protocol Internet Connections (MP-QUIC) uplink data flow, and (iv) a Stream Control Transmission Protocol (SCTP) uplink data flow.

(B5) Any one of the methods denoted as (B1) through (B4) may further include (i) receiving a first downlink data flow at the subscriber link aggregation element via the first logical network link, (ii) receiving a second downlink data flow at the subscriber link aggregation element via the second logical network link, and (iii) aggregating the first downlink data flow and the second downlink data flow at the subscriber link aggregation element.

(B6) In any one of the methods denoted as (B1) through (B5), (i) the access communication network may be a cable communication network operating according to a Data Over Cable Service Interface Specification (DOCSIS) communication protocol, (ii) the first network termination device may be a first cable modem, and (iii) the second network termination device may be a second cable modem.

(B7) In the method denoted as (B6), each of the first logical network link and the second logical network link may comply with a DOCSIS L2VPN specification.

(B8) In any one of the methods denoted as (B1) through (B7), (i) the access communication network may include a coaxial cable plant, (ii) the first communication resources of the access communication network may include one or more first frequency ranges of the coaxial cable plant, and (iii) the second communication resources of the access communication network may include one or more second frequency ranges of the coaxial cable plant.

(B9) In any one of the methods denoted as (B1) through (B5), (i) the access communication network may be a passive optical network (PON), (ii) the first network termination device may be one of a first optical network unit (ONU) and a first optical network termination (ONT), and (iii) the second network termination device may be one of a second ONU and a second ONT.

(B10) In any one the methods denoted as (B1) through (B5), as well as in the method denoted as (B9), (i) the access communication network may include an optical fiber plant, (ii) the first communication resources of the access communication network may include one or more first wavelength ranges of the optical fiber plant, and (iii) the second communication resources of the access communication network may include one or more second wavelength ranges of the optical fiber plant.

(B11) In any one of the methods denoted as (B1) through (B5), (i) the access communication network may be a cellular wireless communication network operating according to a Third Generation Partnership Project (3GPP) communication protocol, (ii) the first network termination device may be a first cellular wireless modem, and (iii) the second network termination device may be a second cellular wireless modem.

(B12) In any one of the methods denoted as (B1) through (B5), as well as in the method denoted as (B11), (1) the access communication network may include a cellular wireless base station, (2) the first communication resources of the access communication network may include one or more of (i) a first set of frequency resources of the cellular wireless base station, (ii) a first set of time resources of the cellular wireless base station, (iii) a first set of antenna resources of the cellular wireless base station, (iv) a first set of power resources of the cellular wireless base station, and (3) the second communication resources of the access communication network may include one or more of (i) a second set of frequency resources of the cellular wireless base station, (ii) a second set of time resources of the cellular wireless base station, (iii) a second set of antenna resources of the cellular wireless base station, and (iv) a second set of power resources of the cellular wireless base station.

(B13) In any one of the methods denoted as (B1) through (B5), as well as in the method denoted as (B11), (i) the access communication network may include a first cellular wireless base station and a second cellular wireless base station, (ii) the first communication resources of the access communication network may include communication resources of the first cellular wireless base station, and (iii) the second communication resources of the access communication network may include communication resources of second cellular wireless base station.

(B14) In any one of the methods denoted as (B1) through (B5), (i) the access communication network may be a satellite wireless communication network, (ii) the first network termination device may be a first satellite wireless modem, and (iii) the second network termination device may be a second satellite wireless modem.

(B15) In any one of the methods denotd as (B1) through (B5), as well as in the method denoted as (B14), (1) the access communication network may include a satellite, (2) the first communication resources of the access communication network may include one or more of (i) a first set of frequency resources of the satellite, (ii) a first set of time resources of the satellite, (iii) a first set of antenna resources of the satellite, and (iv) a first set of power resources of the satellite, and (3) the second communication resources of the access communication network may include one or more of (i) a second set of frequency resources of the satellite, (ii) a second set of time resources of the satellite, (iii) a second set of antenna resources of the satellite, and (iv) a second set of power resources of the satellite.

(B16) In any one of the methods denoted as (B1) through (B5), as well as in the method denoted as (B14), (i) the access communication network include be a first satellite and a second satellite, (ii) the first communication resources of the access communication network may include communication resources of the first satellite, and (iii) the second communication resources of the access communication network may include communication resources of the second satellite.

(B17) Any one of the methods denoted as (B1) through (B16) may further include (i) at the subscriber link aggregation element, splitting the uplink communication traffic into a third uplink data flow as well as the first uplink data flow and the second uplink data flow, and (ii) sending the third uplink data flow to the provider link aggregation element via a third logical network link, the third logical network link including a third network termination device and communicatively coupling the subscriber link aggregation element with the provider link aggregation element, the third network termination device being located at the subscriber’s location and being provisioned third communication resources of the access communication network, the third communication resources of the access communication network being different from each of the first communication resources of the access communication network and the second communication resources of the access communication network.

(C1) A method for network termination device aggregation includes (i) transmitting first Layer-2 data frames between a provider link aggregation element and a subscriber link aggregation element using a first logical network link including a first network termination device and (ii) transmitting second Layer-2 data frames between the provider link aggregation element and the subscriber link aggregation element using a second logical network link including a second network termination device, wherein the first network termination device and the second network termination device are provisioned different respective communication resources of a common access communication network.

(C2) In the method denoted as (C1), (i) the access communication network may operate according to a first communication protocol that is different from an Ethernet communication protocol, (ii) the first Layer-2 data frames may include a plurality of first Ethernet data frames encapsulated within respective first Layer-2 data frames adhering to the first communication protocol, and (iii) the second Layer-2 data frames may include a plurality of second Ethernet data frames encapsulated within respective second Layer-2 data frames adhering to the first communication protocol.

(C3) In the method denoted as (C2), the first communication protocol may be one of a Data Over Cable Service Interface Specification (DOCSIS) communication protocol, a passive optical network (PON) communication protocol, a Third Generation Partnership Project (3GPP) communications protocol, and a satellite wireless communications protocol.

(C4) In any one of the methods denoted as (C1) through (C3), each of the first logical network link and the second logical network link may comply with a DOCSIS L2VPN specification.

(C5) Any one of the methods denoted as (C1) through (C4) may further include controlling each of the first logical network link and the second logical network link at least partially using a link aggregation control protocol (LACP).

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A method for network termination device aggregation, the method comprising:
provisioning a first network termination device at a subscriber’s location to use first communication resources of an access communication network;
provisioning a second network termination device at the subscriber's location to use second communication resources of the access communication network, the second communication resources of the access communication network being different from the first communication resources of the access communication network;
at a provider link aggregation element, splitting downlink communication traffic destined for the subscriber’s location into at least a first downlink data flow and a second downlink data flow;
transmitting the first downlink data flow to a subscriber link aggregation element via a first logical network link, the first logical network link including the first network termination device and communicatively coupling the subscriber link aggregation element with the provider link aggregation element; and
transmitting the second downlink data flow to the subscriber link aggregation element via a second logical network link, the second logical network link including the second network termination device and communicatively coupling the subscriber link aggregation element with the provider link aggregation element.

2. The method of claim 1, wherein each of the first downlink data flow and the second downlink data flow is a respective Layer-2 downlink data flow.

3. The method of claim 1, wherein:
each of the first downlink data flow and the second downlink data flow is a respective Ethernet downlink data flow; and
the access communication network operates according to one or more of (i) a Data Over Cable Service Interface Specification (DOCSIS) communication protocol, (ii) a passive optical network (PON) communication protocol, (iii) a cellular wireless communication protocol, and (iv) a satellite wireless communication protocol.

4. The method of claim 1, wherein each of the first downlink data flow and the second downlink data flow is one of (i) a Multiprotocol Layer Switching (MPLS) downlink data flow, (ii) a Multipath Transmission Control Protocol (MP-TCP) downlink data flow, (iii) a Multi-path Quick User Datagram Protocol Internet Connections (MP-QUIC) downlink data flow, and (iv) a Stream Control Transmission Protocol (SCTP) downlink data flow.

5. The method of claim 1, further comprising aggregating the first downlink data flow and the second downlink data flow at the subscriber link aggregation element.

6. The method of claim 5, further comprising:
transmitting a first uplink data flow from the subscriber link aggregation element to the provider link aggregation element via the first logical network link;
transmitting a second uplink data flow from the subscriber link aggregation element to the provider link aggregation element via the second logical network link; and
aggregating the first uplink data flow and the second uplink data flow at the provider link aggregation element.

7. The method of claim 1, further comprising controlling each of the first logical network link and the second logical network link at least partially using a control protocol.

8. The method of claim 1, wherein:
the access communication network is a cable communication network operating according to a Data Over Cable Service Interface Specification (DOCSIS) communication protocol;
the first network termination device is a first cable modem; and
the second network termination device is a second cable modem.

9. The method of claim 8, wherein each of the first logical network link and the second logical network link complies with a DOCSIS L2VPN specification.

10. The method of claim 1, wherein:
the access communication network comprises a coaxial cable plant;
the first communication resources of the access communication network comprise one or more first frequency ranges of the coaxial cable plant; and
the second communication resources of the access communication network comprise one or more second frequency ranges of the coaxial cable plant.

11. The method of claim 1, wherein:
the access communication network is a passive optical network (PON);
the first network termination device is one of a first optical network unit (ONU) and a first optical network termination (ONT); and
the second network termination device is one of a second ONU and a second ONT.

12. The method of claim 1, wherein:
the access communication network is a cellular wireless communication network operating according to a Third Generation Partnership Project (3GPP) communication protocol;
the first network termination device is a first cellular wireless modem; and
the second network termination device is a second cellular wireless modem.

13. The method of claim 1, wherein:
the access communication network is a satellite wireless communication network;
the first network termination device is a first satellite wireless modem; and
the second network termination device is a second satellite wireless modem.

14. The method of claim 1, further comprising:
provisioning a third network termination device at the subscriber's location to use third communication resources of the access communication network, the third communication resources of the access communication network being different from the first communication resources of the access communication network and the second communication resources of the access communication network;
at the provider link aggregation element, splitting the downlink communication traffic destined for the subscriber’s location into a third downlink data flow as well as the first downlink data flow and the second downlink data flow; and
transmitting the third downlink data flow to the subscriber link aggregation element via a third logical network link, the third logical network link including the third network termination device and communicatively coupling the subscriber link aggregation element with the provider link aggregation element.

15. A method for network termination device aggregation, the method comprising:
at a subscriber link aggregation element, splitting uplink communication traffic into at least a first uplink data flow and a second uplink data flow;
sending the first uplink data flow to a provider link aggregation element via a first logical network link, the first logical network link including a first network termination device and communicatively coupling the subscriber link aggregation element with the provider link aggregation element, the first network termination device being located at a subscriber’s location and being provisioned first communication resources of an access communication network; and
sending the second uplink data flow to the provider link aggregation element via a second logical network link, the second logical network link including a second network termination device and communicatively coupling the subscriber link aggregation element with the provider link aggregation element, the second network termination device being located at the subscriber’s location and being provisioned second communication resources of the access communication network, the second communication resources of the access communication network being different from the first communication resources of the access communication network.

16. The method of claim 15, wherein each of the first uplink data flow and the second uplink data flow is a respective Layer-2 uplink data flow.

17. The method of claim 15, wherein:
each of the first uplink data flow and the second uplink data flow is a respective Ethernet uplink data flow; and
the access communication network operates according to one or more of (i) a Data Over Cable Service Interface Specification (DOCSIS) communication protocol, (ii) a passive optical network (PON) communication protocol, (iii) a cellular wireless communication protocol, and (iv) a satellite wireless communication protocol.

18. A method for network termination device aggregation, the method comprising:
transmitting first Layer-2 data frames between a provider link aggregation element and a subscriber link aggregation element using a first logical network link including a first network termination device; and
transmitting second Layer-2 data frames between the provider link aggregation element and the subscriber link aggregation element using a second logical network link including a second network termination device,
wherein the first network termination device and the second network termination device are provisioned different respective communication resources of a common access communication network.

19. The method of claim 18, wherein:
the access communication network operates according to a first communication protocol that is different from an Ethernet communication protocol;
the first Layer-2 data frames comprise a plurality of first Ethernet data frames encapsulated within respective first Layer-2 data frames adhering to the first communication protocol; and
the second Layer-2 data frames comprise a plurality of second Ethernet data frames encapsulated within respective second Layer-2 data frames adhering to the first communication protocol.

20. The method of claim 19, wherein the first communication protocol is one of a Data Over Cable Service Interface Specification (DOCSIS) communication protocol, a passive optical network (PON) communication protocol, a Third Generation Partnership Project (3GPP) communications protocol, and a satellite wireless communications protocol.
